(19) United States
(12) Patent Application Publication
(10) Pub. No.: US 2010/0298131 A1
(43) Pub. Date: Nov. 25, 2010

(54) Catalyst For Hydrogen Production By Autothermal Reforming, Method Of Making Same And Use Thereof

(76) Inventors: ChangJun Ni, Dalian (CN); Akira Okada, Shizuoka (JP); Shudong Wang, Dalian (CN); Yuming Xie, Sugar Land, TX (US); Zhongshan Yuan, Dalian (CN)

Correspondence Address: CORNING INCORPORATED, SP-TI-3-1, CORNING, NY, 14831, US

(21) Appl. No.: 12/602,030

(22) PCT Filed: May 29, 2008
(86) PCT No.: PCT/US08/06817

§ 371 Date: May 12, 2010

(30) Foreign Application Priority Data
May 31, 2007 (CN) 200710106098.9

(51) Int. Cl. B01J 23/10

(52) U.S. Cl. 502/303; 502/304

(57) ABSTRACT

Provided in the present invention is a catalyst for an ATR (autothermal reforming) process of hydrogen production, as well as the methods to prepare and use it. The catalyst comprises a precious metal of the platinum family (e.g., Pt, Pd, Ru, Rh, Ir) and combinations and mixtures thereof as the active component, an alkali metal oxide and/or alkaline metal oxide as the first additive, and a CeO₂-based composite oxide as the second additive. The catalyst can be used in pellet form, or may be formed into a monolithic form with all the catalytic active components and additives loaded on a support with a regular structure, such as a ceramic honeycomb, a metal honeycomb, or a metal foam.

### TECHNICAL FIELD

The present invention relates to a catalyst and methods for making and using the same. In particular, the present invention relates to an autothermal reforming (“ATR”) catalyst, and methods for making and using the same.

### BACKGROUND

As a high efficiency and clean energy carrier, hydrogen is considered as the ideal fuel for a fuel cell. However, the lack of a widely available and reliable hydrogen source is a technical barrier for the commercialization of fuel cell technology. In the absence of large capacity hydrogen storage and delivering systems as well as the infrastructure, as a near-term solution, it would be a better choice to provide a distributed fuel cell power station, a residential combined heat and power (CHP) system, and other small power-supply system, with hydrogen being supplied from fossil fuels through on-site reforming process. In this respect, natural gas with methane as the major component has attracted special attention due to a higher H/C ratio, no toxicity, and sufficient infrastructure such as gas pipelines.

Hydrogen can be produced from methane/natural gas via a syngas (H₂+CO) process. This process mainly includes three technical approaches: steam reforming (SR), partial oxidation reforming (POX), and autothermal reforming (ATR), of which SR process is the main one being used in the commercial production of hydrogen from natural gas.

It is not practical to apply the traditional, large-scale hydrogen production process to the hydrogen source for fuel cells of distributed on-site hydrogen production. Besides cost, what is more important is the difference in the mode of operation. A hydrogen source system for distributed on-site hydrogen production requires a small volume, light weight, fast startup, and capability of frequent startup and shutdown cycles. It is very difficult for either the technical process or the catalyst for traditional commercial hydrogen production from natural gas to meet the requirements described above. Compared with SR and POX processes, ATR process has many advantages such as high efficiency, quick loading transition, low operating temperature, fast startup, and simplicity and light weight with respect to reactor design, as well as having many materials to choose from. Therefore, ATR is suitable for the hydrogen source of distributed fuel cell power systems.

The critical component of methane ATR process useful for the hydrogen source of fuel cells is the ATR catalyst. The catalyst should not only exhibit activity for both SR and POX (or complete oxidation) reactions, but also have high-temperature resistance, sulfur tolerance, and resistance against carbon deposits. Compared with a Ni-based catalyst, a catalyst made of a precious group metal (“PGM”) of the platinum family has a relatively higher cost, but it indeed has greater advantages with respect to properties such as catalytic activity, stability, operation flexibility, impact resistance, and carbon-deposit resistance. Therefore, the hydrogen source systems for fuel cells of distributed methane ATR hydrogen production developed in the world mostly employ a PGM catalyst.

When methane ATR process is used in the distributed fuel-cell hydrogen source system, the catalyst is required to able to not only maintain a high activity and stability, but also effectively reduce the content of CO in the reformate gas while maintaining a high hydrogen yield, so as to provide favorable conditions for the subsequent CO water-gas shift process and CO preferential oxidation process so that the overall hydrogen source system will be more compact and integrated. Besides, it is required that the ATR process does not have a high pressure drop, which is more favorable for the design, manufacture, and operation of the overall hydrogen source system, and for the integrated operation of the fuel cell. Due to some significant advantages of the catalyst with a monolithic structure, catalysts such as a ceramic honeycomb or metal honeycomb are often used in ATR reactors of the hydrogen source system for the distributed fuel cells.

Reported PGM catalysts of the methane ATR process are mostly based on SR catalysts modified to enhance their activity and high-temperature stability, such as: precious metals loaded on a high-temperature-stable alumina support doped with metal oxides, precious metals loaded on a spinel or perovskite support, precious metals loaded on a transition metal oxide or rare earth composite oxide support, etc. Performances of these catalysts when used for the hydrogen source system of the distributed fuel cell remain to be enhanced: a) activity and stability of the catalysts are not yet adequate, b) the impact resistance of the catalysts under harsh operating conditions such as repeated startup and shutdown is yet to be verified and enhanced, and c) CO content in the reformate gas is yet to be further reduced.

Hence, there is a need to develop a catalyst for ATR hydrogen production from methane that has a high activity, high selectivity, good impact resistance, and long service life, and to enhance the various properties of the catalyst by modification of the method used to prepare the catalytic materials and the process conditions under which the catalysts are used.

### SUMMARY

A first aspect of the present invention is a catalyst for an ATR process characterized by comprising an active component, a first additive, and a second additive, wherein:

the active component is selected from precious metals of the platinum family and combinations and mixtures thereof, having an amount by weight thereof, based on the weight of metal(s) in elemental state, from 0.01% to 10% of the total weight of the active component, the first additive and the second additive;

the first additive is selected from alkali metal oxides, alkaline earth metal oxides and combinations and mixtures thereof, having an amount by weight thereof, based on the weight of oxides, from 1% to 8% of the total weight of the active component, the first additive and the second additive; and
the second additive is selected from CeO₂-based composite oxides, wherein the mole percentage of CeO₂ in the second additive is from 1% to 99%, and the amount of the second additive, based on the weight of oxides, is from 15% to 99% of the total weight of the active component, the first additive and the second additive.

In certain embodiments of the catalyst of the present invention, the active component is selected from Pt, Pd, Ru, Rh, Ir, and combinations and mixtures thereof. In certain other embodiments of the catalyst of the present invention, the active component is selected from Rh, Rh—Pd combination or mixture, Rh—Ir combination or mixture, and Rh—Pt combination or mixture.

In certain embodiments of the catalyst of the present invention, the amount of the precious metal by weight, based on the weight of metal(s) in elemental state, is from 0.02% to 10% of the total weight of the active component, the first additive, and the second additive; in certain other embodiments from 0.02% to 8%; in certain other embodiments from 0.05% to 8%; in certain other embodiments from 0.05% to 5%; in certain other embodiments from 0.1% to 5%.

In certain embodiments of the catalyst of the present invention, the first additive described above is an alkali metal oxide and/or alkaline earth metal oxide such as Na₂O, K₂O, MgO, CaO, SrO, BaO, and combinations and mixtures, and is preferably K₂O, MgO, and CaO in certain other embodiments. In certain embodiments of the catalyst of the present invention, the content of the first additive, based on the weight of oxides, is from 1.1% to 8% of the total weight of the active component, the first additive, and the second additive; in certain other embodiments from 1.2% to 8%, in certain other embodiments from 1.5% to 6%, in certain other embodiments from 1.5% to 5%, and in certain other embodiments from 2% to 4%.

In certain embodiments of the catalyst of the present invention, the second additive is a two- or three-member composite material of CeO₂ and an oxide of a metal selected from: La, Pr, Nd, Sm, Eu, Gd, Y and Zr and combinations thereof. In certain embodiments of the catalyst of the present invention, the second additive is selected from: a Ce—Zr two-member composite oxide, a Ce—Sm two-member composite oxide, and a Ce—Zr—Y three-member composite oxide. In certain embodiments of the catalyst of the present invention, the content of the second additive is from 16% to 99% of the total weight of the active component, the first additive, and the second additive; in certain other embodiments from 20% to 90%, in certain other embodiments from 20% to 80%, in certain other embodiments from 25% to 80%, and in certain other embodiments from 30% to 60%. In certain embodiments of the catalyst of the present invention, the mole percentage of CeO₂ in the second additive is from 2% to 99% of the total amount in moles of the second additive, in certain other embodiments from 5% to 90%, in certain other embodiments from 10% to 80%, in certain other embodiments from 20% to 80%, in certain other embodiments 25% to 75%, in certain other embodiments 30% to 70%, and in certain other embodiments from 40% to 60%.

In certain embodiments of the catalyst of the present invention, the second additive is a single-phase solid solution formed by CeO₂ and other oxides. In certain embodiments of the catalyst of the present invention, the second additive is a microcrystalline mixture formed by CeO₂ and other oxides. In other embodiments of the catalyst of the present invention, the second additive is a complete two-member or three-member composite formed by CeO₂ and other oxides.

In certain embodiments of the catalyst of the present invention, the first additive is at least partially dispersed on the surface of the second additive described above. In certain embodiments of the catalyst of the present invention, part of the first additive enters the second additive to form a composite with it.

In certain embodiments of the catalyst of the present invention, the catalyst is essentially free of components other than the active component, the first additive and the second additive, with the second additive acting as a physical support of the active component.

In certain embodiments of the catalyst of the present invention, the catalyst further comprises an inert support material that acts as a physical support for the active component, the first additive and the second additive.

In certain embodiments of the catalyst of the present invention, the inert support is selected from α-Al₂O₃, MgAl₂O₄, and CaTiO₃, with said catalyst being in pellet form.

In certain embodiments of the catalyst of the present invention, the catalyst is in a monolithic form, and the inert support material is selected from a ceramic honeycomb, a metal honeycomb and a metal foam.

The second aspect of the present invention relates to a method for making various catalysts described above that do not contain supports other than the active component, the first additive, and the second additive, characterized in that the process comprises:

(19-1) providing a CeO₂-based composite oxide material as a catalyst precursor A1; in certain embodiments, A1 may be in powder form;

(19-2) loading a compound of an alkali metal or an alkaline earth metal onto the catalyst precursor A1 resulting from step (19-1), followed by drying and calcination, to obtain a catalyst precursor B1;

(19-3) loading a compound of a precious metal of the platinum family onto the catalyst precursor B1 resulting from step (19-2), followed by drying and calcination, to obtain a catalyst C1 in the oxidized state; and
(19-4) reducing the catalyst C1 resulting from step (19-3).

In certain embodiments of the methods according to the second aspect of the present invention, the catalyst precursor A 1 in powder form in Step (19-1) can be prepared using homogenous precipitation, comprising the following steps:

(22-1) preparing an aqueous solution comprising urea, a salt of Ce, a salt of another lanthanide and/or another transition metal;

(22-2) heating the solution resulting from step (22-1) until urea decomposes, with the solution undergoing a homogeneous-phase precipitation, to obtain a precursor of a CeO₂-based composite oxide; and
(22-3) drying and calcining the precursor obtained in step (22-2) to obtain the catalyst precursor A1.

In certain embodiments of the methods according to the second aspect of the present invention, the catalyst precursor A1 in powder form in Step (19-1) can be prepared using a microemulsion method, comprising the following steps:

(23-1) preparing an aqueous emulsion comprising a salt of Ce, a salt of another lanthanide and/or another transition metal, a surfactant, a co-surfactant, and an oil-phase solvent;

(23-2) preparing an aqueous emulsion comprising an ammonia, a surfactant, a co-surfactant, and an oil-phase solvent;

(23-3) mixing the emulsions obtained from steps (23-1) and (23-2);

(23-4) separating the precursor of CeO₂-based composite oxide material formed in the mixed emulsion obtained in step (23-3); and

(23-5) drying and calcining the precursor of CeO₂-based composite oxide material resulting from step (23-4) to obtain a catalyst precursor A1 in powder form.

In certain embodiments of the methods according to the second aspect of the present invention, the catalyst precursor A1 in powder form in Step (19-1) can be prepared using the method of co-precipitation, comprising the following steps:

(24-1) preparing an aqueous solution comprising a salt of Ce, a salt of another lanthanide and/or another transition metal;

(24-2) adding ammonia into the solution of the mixed salts obtained in step (24-1) until a precipitate of a precursor of a CeO₂-based composite oxide is obtained;

(24-3) drying and calcining the precursor of the CeO₂-based composite oxide obtained in step (24-2) to obtain the catalyst precursor A1 in powder form.

The third aspect of the present invention relates to a method for making various catalysts described above that contain supports other than the active component, the first additive, and the second additive, characterized in that the method comprises:

(20-1) loading a CeO₂-based composite oxide material onto a catalyst support, followed by drying and calcination, to obtain a catalyst precursor A2;

(20-2) loading a compound of an alkali metal or an alkaline earth metal onto the catalyst precursor A2 resulting from step (20-1), followed by drying and calcination, to obtain a catalyst precursor B2;

(20-3) loading a compound of a precious metal of the platinum-family onto the catalyst precursor B2 resulting from step (20-2), followed by drying and calcination, to obtain a catalyst C2 in the oxidized state; and

(20-4) reducing the catalyst C2 resulting from step (20-3).

In certain embodiments of the method according to the third aspect of the present invention, Step (20-1) includes providing α-Al₂O₃, MgAl₂O₃, CaTiO₃, or other refractory material as the support for the catalyst.

In certain embodiments of the method also according to the third aspect of the present invention, step (20-1) comprises loading a sol or an aqueous slurry comprising cerium, another lanthanide and/or another transition metal onto a monolithic catalyst support.

In certain embodiments of the method according to the third aspect of the present invention, step (20-1) comprises loading a colloidal sol onto the catalyst support; wherein the colloidal sol is prepared using a method comprising the following steps:

(27-1) preparing an aqueous solution comprising a salt of Ce, a salt of another lanthanide and/or another transition metal;

(27-2) adding ammonia into the solution of the mixed salts obtained in step (27-1) until a gel is obtained; and

(27-3) adding nitric acid (HNO₃) into the gel obtained in step (27-2).

In certain embodiments of the method also according to the third aspect of the present invention, step (20-1) comprises loading an aqueous slurry onto the catalyst support, wherein the slurry comprises powdered CeO₂-based composite oxide material, CeO₂-based composite oxide sol, and nitric acid. In certain more specific embodiments, step (20-1) comprises a step involving homogeneous precipitation, co-precipitation, or microemulsion for the preparation of CeO₂-based composite oxide material in the aqueous slurry.

In certain embodiments of the method according to the third aspect of the present invention, step (20-1) comprises the following steps to prepare the CeO₂-based composite oxide sol-gel in the aqueous slurry:

(30-1) preparing an aqueous solution comprising a salt of Ce, a salt of another lanthanide and/or another transition metal;

(30-2) adding ammonia into the solution of the mixed salts obtained in step (30-1) until a gel is obtained; and

(30-3) adding nitric acid (HNO₃) into the gel obtained in step (30-2).

The catalysts for an ATR process as provided in certain embodiments of the present invention have one or more of the advantages of high activity, low CO content in the reformate gas, impact resistance, and long service life. Through the modified method of preparation and method of use as provided in certain embodiments of the present invention, such as the preparation of CeO₂-based composite oxides to form a single-phase solid solution, reduction of the catalyst before use, etc., the advantages of the catalyst described above is further enhanced.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

FIGS. 1A, 1B, 1C and 1D are transmission electron microscope (TEM) images of the Ce—Zr composite oxide powder prepared according to certain embodiments of the present invention (FIG. 1A: (NH₄)₂Ce(NO₃)₆ as precursor using homogenous precipitation; FIG. 1B: (Ce(NO₃)₃.6H₂O as precursor using homogeneous precipitation; FIG. 1C: Ce(NO₃)₃.6H₂O as precursor using the microemulsion method; FIG. 1D: Ce(NO₃)₃.6H₂O as precursor using co-precipitation).

FIG. 2 shows the X-ray diffraction patterns of the Ce—Zr composite oxide powder prepared according to certain embodiments of the present invention (2.1: Ce(NO₃)₃.6H₂O as precursor using the method of co-precipitation; 2.2: Ce(NO₃)₃.6H₂O as precursor using the microemulsion method; 2.3: (Ce(NO₃)₃.6H₂O as precursor using the method of homogeneous precipitation; 2.4: (NH₄)₂Ce(NO₃)₆ as precursor using the method of homogenous precipitation).

FIG. 3 shows methane conversion as a function of the reaction time of the catalyst (Sample 1, Rh/MgO/Ce_{0.5}/Zr_{0.5}O₂) prepared according to an embodiment of the present invention (GHSV=5000 hr⁻¹, O₂/C=0.46, H₂O/C=2.0, T=800° C.).

FIG. 4A is a bar chart showing and comparing methane conversion of a series of catalysts comprising the CeO₂-based composite oxide (Rh/MgO/Ce-M-O/α-Al₂O₃ pellet catalysts) according to certain embodiments of the present invention, as well as certain catalysts not based on the present invention. FIG. 4B shows the CO concentration in the reformate gases corresponding to the catalysts in FIG. 4A (GHSV=20000 hr⁻¹, O₂/C=0.46, H₂O/C=2.0, T=800° C.).

FIG. 5 is a bar chart comparing methane conversion rates of a series of catalysts of the present invention doped with alkali metal and/or alkaline earth metal oxides (Rh/M-O/Ce—Zr—O/α-Al₂O₃ pellet catalysts) (GHSV=20000 hr⁻¹, O₂/C=0.46, H₂O/C=2.0, T=800° C.).

FIG. 6 shows the H₂-TPR profiles of a series of catalysts according to certain embodiments of the present invention, as well as certain catalysts not according to the present invention (Rh/MgO/Ce—Zr—O/α-Al₂O₃, Rh/Ce—Zr—O/α-Al₂O₃, and Rh/α-Al₂O₃).

FIG. 7 is a diagram showing methane conversion rates as a function of time of a series of catalysts according to certain embodiments of the present invention, as well as certain catalysts not according to the present invention (Rh/MgO/Ce—Zr—O/α-Al₂O₃, Rh/Ce—Zr—O/α-Al₂O₃, and Rh/α-Al₂O₃) (GHSV=20000 hr⁻¹, O₂/C=0.46, H₂O/C=2.0, T=800° C.).

FIG. 8A is a bar chart showing and comparing the different methane conversion rates of a series of catalysts comprising Ce_{0.5}Zr_{0.5}O₂ as an additive according to certain embodiments of the present invention, as well as certain catalysts not according to the prevent invention (Rh/MgO/MO/cordierite) comprising oxide such as Al₂O₃, TiO₂, ZrO₂, CeO₂ as an additive. FIG. 8B is a bar chart showing and comparing the CO concentrations in different reformate gases corresponding to the catalysts in FIG. 8A (GHSV=5000 hr⁻¹, O₂/C=0.46, H₂O/C=2.0, T=800° C.).

FIG. 9A is a bar chart showing and comparing the different methane conversion rates of a series of catalysts containing different amounts of Ce_{0.5}Zr_{0.5}O₂ (Rh/MgO/Ce_{0.5}Zr_{0.5}O₂/cordierite). FIG. 9B is a bar chart showing and comparing the CO concentration in different reformate gases corresponding to the catalysts in FIG. 9A (GHSV=5000 hr⁻¹, O₂/C=0.46, H₂O/C=2.0, T=800° C.).

FIG. 10 is a diagram showing the different methane conversion rates of a series of ceramic honeycomb monolithic catalysts comprising Ce—Zr composite oxides (Rh/MgO/Ce—Zr—O/cordierite ceramic honeycomb monolithic catalysts) (GHSV=5000 hr⁻¹, O₂/C=0.46, H₂O/C=2.0, T=800° C.).

FIGS. 11A and 11B are scanning electron microscope (SEM) images of the ceramic honeycomb catalyst coated with Ce—Zr sol (FIG. 11A) and Ce—Zr slurry (FIG. 11B), respectively.

FIG. 12 is a diagram showing the BJH pore-size distribution of a series of Ce—Zr composite oxide powders.

FIG. 13 is a diagram showing and comparing the different methane conversion rates and the stability of the methane conversion rates of a series of ceramic honeycomb catalysts comprising Ce—Zr composite oxides with different Ce/Zr ratios (Rh/MgO/Ce—Zr—O/cordierite) (GHSV=5000 hr⁻¹, O₂/C=0.46, H₂O/C=2.0, T=800° C.).

FIG. 14 is a diagram showing and comparing the different methane conversion rates of a series of ceramic honeycomb catalysts comprising precious metals of different platinum family elements or combinations thereof (PGM/MgO/Ce_{0.5}Zr_{0.5}O₂/cordierite) (GHSV=5000 hr⁻¹, O₂/C=0.46, H₂O/C=2.0, T=800° C.).

FIG. 15 is a diagram showing and comparing the different methane conversion rates and the stability of the methane conversion rates of a series of ceramic honeycomb catalysts comprising honeycomb supports with different pore densities (Rh/MgO/Ce_{0.5}Zr_{0.5}O₂/cordierite) (GHSV=12000 hr⁻¹, O₂/C=0.46, H₂O/C=2.0, T=800° C.).

FIG. 16A and FIG. 16B are diagrams showing and comparing the stability of two kinds of honeycomb catalysts (FIG. 16A: Rh/MgO/Ce_{0.5}Zr_{0.5}O₂/cordierite prepared from powder A; FIG. 16B: Rh/MgO/Ce—Zr—O/cordierite prepared from powder B) with and without 10% H₂-90% N₂ pre-reduction before the reaction (GHSV=5000 hr⁻¹, O₂/C=0.46, H₂O/C=2.0, T=800° C.).

FIG. 17 is a diagram showing the methane conversion rate and the impact resistance of a honeycomb catalyst (Rh/MgO/Ce_{0.5}Zr_{0.5}O₂/cordierite) according to an embodiment of the present invention, under the operation conditions of repeated startup and shutdown (GHSV=5000 hr⁻¹, O₂/C=0.46, H₂O/C=2.0, T=800° C.).

FIG. 18 is a diagram showing the result of a 2000-hour stability experiment of a honeycomb catalyst (Rh/MgO/Ce_{0.5}Zr_{0.5}O₂/cordierite) according to one embodiment of the present invention (GHSV=5000 hr⁻¹, O₂/C=0.46, H₂O/C=2.0, T=800° C.).

FIG. 19 is a diagram showing the result of a stability experiment using a honeycomb catalyst (Rh/MgO/Ce_{0.5}Zr_{0.5}O₂/cordierite) according to one embodiment of the present invention in the simulated natural gas (GHSV=5000 hr⁻¹, O₂/C=0.46-0.48, H₂O/C=2.0, T=800° C.).

### SPECIFIC EMBODIMENTS

Unless otherwise indicated, all numbers such as those expressing weight percents of ingredients, dimensions, and values for certain physical properties used in the specification and claims are to be understood as being modified in all instances by the term “about.” It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique. As used herein, in describing and claiming the present invention, the use of the indefinite article “a” or “an” means “at least one,” and should not be limited to “only one” unless explicitly indicated to the contrary. Thus, for example, reference to “an alkali metal” includes embodiments having two or more such elements, unless the context clearly indicates otherwise.

Unless specified otherwise, the term “X, Y, Z, . . . and combinations thereof” means a group consisting of the following elements: X, Y, Z, . . . , and combinations of any 2, or more than 2 members of X, Y, Z, . . . , at any proportion.

The term “nano-crystalline material” as used herein means a relevant material having a mean crystal size smaller than 500 nm.

The term “aqueous solution” or “aqueous dispersion” as used herein means a material system comprising water and with or without any other solvent. Therefore, an aqueous solution or an aqueous dispersion may also contain, in addition to water, other solvents such as an alcohol, and the like.

The term “Ce—Zr sol” as used herein means a material system comprising Ce and Zr-containing colloidal particles having a mean particle size of 1-100 nm dispersed therein. The pH of such material is typically acidic. In certain embodiments, the pH thereof is from 1 to 5.

The term “composite oxides” as used herein means a mixture of oxides of two or more metal elements.

“Pellet catalyst” described in the present invention in general refers to the catalyst packed in an irregular manner in the reactor when being used. The geometric configuration of a pellet catalyst may be, but is not restricted to, spherical, cylindrical, flake-like, or powdery.

“Monolithic catalyst” as used herein in general refers to the a catalyst arranged in a regular manner in the reactor when being used. The geometric configuration of a monolithic catalyst may be, but is not restricted to, a honeycomb, a foam, a corrugated metal plate, and the like. The catalyst can be prepared in such a way that the active component of the catalyst is loaded in the form of a wash coat onto the surface or the channels of the support; it can also be prepared in such a manner as to extrude the active component of the catalyst as a monolithic unit.

The first additive in the catalyst of the present invention, i.e., the alkali metal or alkaline earth metal oxide, can be present in the catalyst on the surface of the second additive, that is, the CeO₂-based rare earth composite oxide. Alternatively the first additive can also enter into second additive to form a composite oxide with it.

The second additive in the catalyst according to the present invention can be a complete two-member or three-member composite formed by CeO₂ and oxides of another lanthanide or another transition metal. Alternatively, the second additive can also be a microcrystalline mixture formed by CeO₂ and oxides of other lanthanide rare earth elements or other transition metal elements with a mean crystallite size smaller than 500 nm.

A “single-phase solid solution” of the CeO₂-based composite oxide in the catalyst according to the present invention refers to a composite of a single phase formed between CeO₂ and an oxide of another lanthanide and/or another transition metal, where the oxide of the other lanthanide and/or another transition-metal completely enters the crystal lattice of CeO₂. Confirmation of a single-phase solid solution is based on the lack of diffraction peak of the oxide of the other lanthanide or transition metal added to the second additive in the XRD spectrum of the CeO₂-based composite oxide.

An “aqueous slurry” of the CeO₂-based oxide as used herein refers to a normally unstable system formed by solid particles smaller than 100 μm in diameter homogeneously dispersed in an aqueous solution. Stirring is typically needed before use of such slurry to obtain a substantially homogeneously dispersion.

A “precursor” as used herein of the active component or an additive refers to a soluble chemical compound that result in the active component or additive in the catalyst according to the present invention, such as a salt or an oxide, etc. After appropriate treatment, the active component or additive can be obtained from the precursor. In certain embodiments, these precursors can be dissolved in water at room temperature. These precursors include, but are not limited to, nitrates, chlorides, sulfates, oxides, and the like.

The methane conversion rate (“CCH₄”) as used herein is defined as the mole percentage of methane converted from the feedstock gas, that is, the molar amount difference of methane between the feedstock gas and the reforming-product relative to the molar amount of methane in the feedstock gas, expressed in percentage.

The gas hourly space velocity as used herein is defined as the volume of the reactant methane flowing into the reaction system per hour divided by the volume of the catalyst. It is indicated by GHSV, in unit of hr⁻¹.

The oxygen/carbon ratio as used herein is defined as the mole ratio between oxygen and methane in the reactants. It is indicated by O₂/C.

The water/carbon ratio as used herein is defined as the mole ratio between water and methane in the reactants. It is indicated by H₂O/C.

Provided in the present invention is a catalyst for an ATR process, useful for hydrogen production by reforming fuels such as hydrocarbons, alcohols, and ethers, particularly methane/natural gas (such as in the on-site hydrogen production), so as to provide a steady and reliable hydrogen source for fuel cells. In view of the non-steady-state operation characteristic of the process of on-site hydrogen production, it is required that the catalyst not only have good activity and stability, but also have good impact resistance in the process of frequent fast startup and shutdown cycles. Normally used precious metal catalysts, such as the Rh/Al₂O₃ catalyst have advantages over Ni-based and other non-precious metal catalysts in terms of ability to maintain reforming activity, stability, and impact resistance. Rh/Al₂O₃ and other precious metals catalysts are normally used in the process of methane steam-reforming in a reductive atmosphere. However, when used in methane autothermal reforming where the oxidative and reductive atmospheres co-exist, a Rh catalyst, due to insufficient oxidation activity, may have difficult to accomplish effective balance of the exothermic methane oxidation and the endothermic methane steam reforming reactions on the active site of the catalyst. As a result, the activity and stability of the catalyst cannot meet the requirements of an ATR process. Accordingly, in the present invention, an additive comprising CeO₂-based composite oxide, which possesses oxygen storage capacity (“OSC”), is introduced into the catalyst to accomplish the effective balance of the oxidation/reduction activity of the catalyst. CeO₂ and solid solutions containing Ce have been extensively studied and used in automobile exhaust gas purification catalysts and CO water-gas shift catalysts. Because CeO₂ has OSC function under oxidation and reduction conditions, it can activate the hydrocarbons and CO to enhance the catalytic activity. If a two-member or three-member composite oxide of Ce and another lanthanide and/or another transition metal such Zr serves as the support of the metals, the transfer of oxygen can be promoted through the interaction between metals, thus further activating the hydrocarbon and enhancing the performance of the catalyst in oxidation and reduction. As a matter of fact, after CeO₂ is added to Ni/Al₂O₃ catalyst, both activity and coking in methane reforming were remarkably improved. It has been reported in the literature that when NiO/CeO₂—ZrO₂ is used in methane POX reaction, due to the oxygen storage capacity of the CeO₂—ZrO₂ material, the catalyst exhibited higher activity. Accordingly, in the present invention, a CeO₂-based rare earth composite oxide additive is introduced into the precious metal catalyst system of for the ATR process, which, through the interaction between the active component of the precious metal and the CeO₂-based rare earth composite oxide, enhances the exchange capacity of the active oxygen in the catalyst, which, in turn, helps to enhance the activity and stability of the catalyst.

Another purpose of introducing the CeO₂-based rare earth composite oxide into the precious-metals ATR reaction system is to reduce the content of CO in the reformate gas while maintaining the yield of hydrogen. This is extremely important for application of the catalyst of the present invention in the fuel processing system to supply hydrogen to fuel cells. Currently, as the fuel used in proton exchange membrane fuel cells the reformate gas is required to have a CO content reduced to below 50 ppm, or the Pt electrode catalyst of the fuel cell can be poisoned. Hence, after the H₂+CO syngas is obtained in the reforming process, CO in the syngas is required to be reduced to below 1.5% via the CO water-gas shift reaction, to obtain a hydrogen-enriched gas. Next, through the process of CO preferential oxidation, the content of CO in the reformate gas finally meets the requirements of the fuel cell. Because CO water-gas shift reaction is a reversible reaction controlled by thermodynamics at high temperatures, it requires more catalyst and proper temperature control of for the reaction to proceed effectively. Normally, the volume of the CO water-gas shift reactor is the largest in fuel cell H₂-source systems. With a reduction of CO content in the reformate gas, not only will the amount of the catalyst needed for the CO water-gas shift be effectively reduced, but also the heat exchange process of the CO water-gas shift reaction can be simplified, so that the entire fuel processing system becomes more efficient and compact. It is known from the methane autothermal reforming reaction network that, besides major reactions such as methane SR and methane POX or complete oxidation, there are also side reactions such as CO water-gas shift and oxidation of CO to CO₂. With an excellent oxygen storage capacity, the CeO₂-based composite oxide material has been acknowledged as being one that can promote the occurrence of these two reactions. Therefore, with the introduction of a CeO₂-based composite oxide into the methane ATR system, fine tuning and control of the reaction atmosphere can also be accomplished through the OSC function of the CeO₂-based composite oxide, thereby facilitating the occurrence of the CO water-gas shift and CO oxidation, hence effectively reducing CO content in the reformate gas.

Some physical characteristics of the catalytic material of CeO₂-based composite oxides such as the specific surface area, particle size and distribution, pore size distribution, as well as whether a single-phase solid solution has been formed, etc., all directly affect the oxygen exchange capacity of the CeO₂-based composite oxide in high-temperature atmospheres like that of the methane ATR reaction, and will further affect the activity and stability of the catalyst. With the composition and method of preparation of the preferred catalytic materials of CeO₂-based composite oxides provided in certain embodiments of the present invention, a better performance, such as a high specific surface area, high capacity of low-temperature oxygen exchange, thermal stability, etc., are made possible.

Alkali metal and alkaline earth metal oxides as additives in a catalyst for reforming are usually believed to be beneficial for enhancing water adsorption in the reaction process, thereby promoting the reaction between the carbon-containing species on the catalyst surface and the water molecules, thus inhibiting carbon deposition on the catalyst surface. However, in certain embodiments of the present invention, alkali metal and/or alkaline earth metal oxides introduced as an additive have additional new function. This is because, on the one hand, the CeO₂-based composite oxide, slightly alkaline, is capable of attaining the objective of partially inhibiting carbon deposition on the catalyst; on the other hand, for an ATR process, compared to steam reforming, the phenomenon of carbon deposition is not serious. By introducing the additives of alkali metal or alkaline earth metal oxides into the catalyst of the present invention, through the interaction of the alkali metal or alkaline earth metal oxide with the precious metal active component, or with the CeO₂-based composite oxide, the stability of the catalyst can be further enhanced.

In view of the above, the first aspect of the present invention involves the use of a catalyst for an ATR process as described above, and is characterized in that it contains the active component, the first additive, and the second additive, wherein:

the active component is selected from precious metals of the platinum family and combinations and mixtures thereof, having an amount by weight thereof, based on the weight of metal(s) in elemental state, from 0.01% to 10% of the total weight of the active component, the first additive and the second additive;

the first additive is selected from alkali metal oxides, alkaline earth metal oxides and combinations and mixtures thereof, having an amount by weight thereof, based on the weight of oxides, from 1% to 8% of the total weight of the active component, the first additive and the second additive; and

the second additive is selected from CeO₂-based composite oxides, wherein the mole percentage of CeO₂ in the second additive is from 1% to 99%, and the amount of the second additive, based on the weight of oxides, is from 15% to 99% of the total weight of the active component, the first additive and the second additive.

In certain embodiments of the catalyst of the present invention, the active component is selected from Pt, Pd, Ru, Rh, Ir, and combinations and mixtures thereof. In certain other embodiments of the catalyst of the present invention, the active component is selected from Rh, Rh—Pd combination or mixture, Rh—Ir combination or mixture, and Rh—Pt combination or mixture.

In certain embodiments of the catalyst of the present invention, the amount of the precious metal by weight, based on the weight of metal(s) in elemental state, is from 0.02% to 10% of the total weight of the active component, the first additive, and the second additive; in certain other embodiments from 0.02% to 8%; in certain other embodiments from 0.05% to 8%; in certain other embodiments from 0.05% to 5%; in certain other embodiments from 0.1% to 5%. As the catalytic active component, the precious metal directly provides the catalyst of the present invention with the catalytic function. A precious metal used in a large amount will enhance the general catalytic performance, yet too much of the precious metal used will greatly increase the cost of the catalyst. The precious metal as an active component is mostly in elemental state. In certain embodiments of the present invention, at least 98% of the precious metals that serve as the active component are in elemental state, while in certain other embodiments, at least 99% are in elemental state and in still certain other embodiments, at least 99.9% are in elemental state.

In view of the fact that an effective active component needs direct contact with the gas to be treated, the active component must at least be partially dispersed on the surface of the catalyst of the present invention, but it is not ruled out the possibility that part of the active component can be distributed inside the first additive and/or the second additive, and any support materials that may exist. Besides, if a support other than the first additive and the second additive is present, the active component may also be partially dispersed on the surface of that support. In certain embodiments of the catalyst of the present invention, an active component is mainly (for example, at least 50%, including 60%, 70%, 80%, and even 90%) dispersed on the surface of the particles of the second additive and/or the first additive. In certain other embodiments of the catalyst of the present invention, the active component is partially dispersed on the surface of the particles of the additive, and partially distributed on the surface of the support.

In certain other embodiments of the catalyst of the present invention, the first additive described above is an alkali metal oxide and/or alkaline earth metal oxide selected from Na₂O, K₂O, MgO, CaO, SrO, BaO, or combinations and mixtures thereof, but is preferably K₂O, MgO, and CaO in certain embodiments. In certain embodiments of the catalyst of the present invention, the content of the first additive, based on the total amount of the oxides, is from 1.1% to 8% of the total weight of the active component, the first additive, and the second additive; in certain other embodiments from 1.2% to 8%, in certain other embodiments 1.5% to 6%, in certain other embodiments from 1.5% to 6%, and in certain other embodiments from 2% to 4%.

In certain embodiments of the catalyst of the present invention, the second additive is a two- or three-member composite material of CeO₂ and an oxide of a metal selected from: La, Pr, Nd, Sm, Eu, Gd, Y and Zr and combinations thereof. In certain embodiments of the catalyst of the present invention, the second additive is selected from: a Ce—Zr two-member composite oxide, a Ce—Sm two-member composite oxide, and a Ce—Zr—Y three-member composite oxide. In certain embodiments of the catalyst of the present invention, the content of the second additive is from 16% to 99% of the total weight of the active component, the first additive, and the second additive; in certain other embodiments from 20% to 90%, in certain other embodiments from 20% to 80%, in certain other embodiments from 25% to 80%, and in certain other embodiments from 30% to 60%. In certain embodiments of the catalyst of the present invention, the mole percentage of CeO₂ in the second additive is from 2% to 99% of the total amount in moles of the second additive, in certain other embodiments from 5% to 90%, in certain other embodiments from 10% to 80%, in certain other embodiments from 20% to 80%, in certain other embodiments 25% to 75%, in certain other embodiments 30% to 70%, and in certain other embodiments from 40% to 60%.

In certain embodiments of the catalyst of the present invention, the second additive is a single-phase solid solution formed by CeO₂ and other oxides. In certain embodiments of the catalyst of the present invention, the second additive is a microcrystalline mixture formed by CeO₂ and other oxides. In other embodiments of the catalyst of the present invention, the second additive is a complete two-member or three-member composite formed by CeO₂ and other oxides. In certain embodiments of the catalyst of the present invention, the first additive is at least partially dispersed on the surface of the second additive described above. In certain embodiments of the catalyst of the present invention, part of the first additive enters the second additive to form a composite with it. In certain embodiments of the catalyst of the present invention, the catalyst is essentially free of components other than the active component, the first additive and the second additive, with the second additive acting as a physical support of the active component. In certain embodiments of the catalyst of the present invention, the catalyst further comprises an inert support material that acts as a physical support for the active component, the first additive and the second additive. In certain embodiments of the catalyst of the present invention, the inert support is selected from α-Al₂O₃, MgAl₂O₄, and CaTiO₃, with said catalyst being in pellet form.

In certain embodiments of the catalyst of the present invention, the catalyst is in a monolithic form, and the inert support material is selected from a ceramic honeycomb, a metal honeycomb and a metal foam, and the like.

The second aspect of the present invention relates to a method to prepare various catalysts described above that do not contain supports other than the active component, the first additive, and the second additive.

The third aspect of the present invention relates to a method to prepare various catalysts described above that contain supports other than the active component, the first additive, and the second additive.

In the methods for preparing the catalysts described above, CeO₂-based composite oxides can be obtained in several ways. The simplest way comprises loading a solution of a soluble salt containing a certain amount of Ce and another rare earth lanthanide and/or another transition metal directly onto the support of the catalyst, followed by calcination and drying.

In certain embodiments of the present invention, CeO₂-based composite oxides can also be obtained by: forming a colloidal sol comprising CeO₂-based composite oxide, loading the sol onto the support of the catalyst, followed by calcination and drying. The colloidal sol of the CeO₂-based composite oxide can be prepared using the sol-gel method. For example, in the preparation of the Ce—Zr colloidal sol using Ce(NO₃)₃.6H₂O and Zr(NO₃)₄.5H₂O as the precursors, first a certain amount of Ce(NO₃)₃.6H₂O and Zr(NO₃)₄.5H₂O are dissolved, filtered, and mixed, to produce an aqueous mixture solution; next, a the Ce—Zr aqueous solution mixture described above is added dropwise into aqueous ammonia solution at a certain rate, with stirring, until a Ce—Zr hydroxide gel is formed; then, HNO₃ is added dropwise at a certain rate into the gel described above to disintegrate the gel, until the colloid becomes clear. Finally, the clear colloid is stirred and aged continuously, to obtain a stable Ce—Zr colloidal sol.

In certain embodiments of the present invention, CeO₂-based composite oxides can also be prepared using the method of homogenous precipitation. For example, where (NH₄)₂Ce(NO₃)₆ and Zr(NO₃)₄.5H₂O are used as the precursors, first, a certain amount of (NH₄)₂Ce(NO₃)₆, Zr(NO₃)₄.5H₂O, and urea are dissolved in water to obtain an aqueous solution mixture. Next, the solution is heated with stirring until urea is decomposed. Then, after a precipitate is formed, it is stirred at boiling (100° C.) for several hours. After aging, filtering, water washing, and washing with isopropanol, a precursor of the Ce—Zr composite oxide is prepared. Afterwards, the precipitate is dried and calcined, to obtain a powder of the Ce—Zr composite oxide. Slow drying and slow calcining are preferred, for example, drying in a vacuum dryer at 60° C. for over 15 hours, and heating in a muffle furnace at a temperature elevation rate of 2.5° C./min until 500° C., where calcination is conducted for 2 hours.

In certain embodiments of the present invention, the CeO₂-based composite oxides can also be prepared using the microemulsion method. For example, where Ce(NO₃)₃.6H₂O and Zr(NO₃)₄.5H₂O are used as the precursors, first, a certain amount of Ce(NO₃)₃.6H₂O, Zr(NO₃)₄.5H₂O and urea are dissolved in water and an aqueous mixture solution is obtained. Next, a prepared solution mixture containing a certain amount of polyoxyethylene octylphenyl ether (NP-10), n-hexanol, and cyclohexane is added to the aqueous solution of Ce—Zr mixture solution described above, to obtain an aqueous emulsion containing Ce, Zr, surfactant, co-surfactant, and oil-phase solvent. An aqueous emulsion containing ammonia, surfactant, co-surfactant, and oil-phase solvent is prepared in the same way. The Ce—Zr microemulsion and the aqueous ammonia microemulsion prepared above are then mixed, and allowed to react with stirring. Reactions take place inside microemulsion droplets. The resulting precipitate is heated and refluxed over a water bath to break the emulsion. Then, the mixture poured into a Bücher funnel and left undisturbed, until the oil phase and the aqueous phase separate completely. After drying the aqueous phase and calcination, a powder of the Ce—Zr composite oxide is obtained. Slow drying and slow calcining are preferred, for example, drying in a vacuum dryer at 70° C. for over 15 hours, and heating in a muffle furnace at a temperature elevation rate of 2.5° C./min until 500° C., where calcination is conducted for over 2 hours.

In certain advantageous embodiments of the present invention, the CeO₂-based composite oxides can also be prepared by means of co-precipitation. For example, where Ce(NO₃)₃.6H₂O and Zr(NO₃)₄.5H₂O are used as the precursors, first, a certain amount of Ce(NO₃)₃.6H₂O and Zr(NO₃)₄.5H₂O are dissolved, filtered, and mixed, to obtain an aqueous mixture solution. Next, using aqueous ammonia as the precipitating agent, an ammonia aqueous solution is added into aqueous Ce—Zr mixture solution dropwise, with stirring, until the pH value is lower than 9. After aging, filtering, and water washing, a precursor of the Ce—Zr composite oxide is prepared. Next, the precipitate prepared is dried and calcined, to obtain a Ce—Zr composite oxide. Slow drying and slow calcining are preferred, for example, drying in a vacuum dryer at 70° C. for over 15 hours, and heating in a muffle furnace at a temperature elevation rate of 2.5° C./min until reaching 500° C., where calcination is conducted for 2 hours.

In certain embodiments of the methods for preparing the catalysts of the present invention, the above-described CeO₂-based composite oxide powder prepared using the method of homogeneous precipitation, the microemulsion method, and the method of co-precipitation is extruded, tableted, or shaped using other methods, then used as the physical support of the catalyst. Afterwards, aqueous solutions of precursors of the first additive of alkali metal or alkaline earth metal oxides and the precious metal catalytic active component are loaded in sequence onto the CeO₂-based composite oxides, dried and calcined at each step, and a pellet catalyst in the oxidized state is thus obtained. The first additive of alkali metal or alkaline earth metal oxides and the catalytic active component described above can be loaded repeatedly until the required load is obtained. The lower limit of the calcining temperature described above is advantageously higher than the operating temperature of the catalyst. For example, if the operating temperature of the ATR process is 750-850° C., then the calcining temperature selected should be over 750° C. However, too high a calcining temperature for the catalyst is not necessary, since calcining at high temperature may easily cause volatilization and loss of the precious metal active component. For example, Rh₂O₃, an active component of the precious metal in oxidized state, may start to undergo decomposition and volatilization at a temperature higher than 800° C. Consequently, the catalysts in the oxidized state described above should be reduced before use, so that the active component of the precious metal is transformed from the oxidized state to the elemental reduced state. Since the melting point of precious metals at elemental state, such as Rh, can be up to 1966° C., this can ensure that the precious metal active component will not be lost due to volatilization in the reaction process. This is particularly important for maintaining a long service life of the catalyst.

In certain embodiments of the methods for preparing the catalysts of the present invention, refractory oxides such as α-Al₂O₃, MgAl₂O₄ (MgO.Al₂O₃), and CaTiO₃ (CaO.TiO₂) may also be used as a physical support of the catalyst on which all components of the catalyst are loaded, to produce a catalyst in pellet form. This approach can improve the economy of the method for making the catalyst, and reduce the production cost. The steps of preparation comprises loading the aqueous solutions of the precursors for the CeO₂-based composite oxide second additive, the alkali metal or alkaline earth metal oxide first additive, and the precious metal catalytic active component in sequence onto the refractory oxide, with drying and calcination in each step, to produce first a pellet catalyst in the oxidized state. Similarly, each step of the loading the components can be repeated until the required load is obtained. The catalyst is preferably reduced and used as a precious metal in the elemental state.

Certain advantageous embodiments of the method for preparing the catalyst according to the present invention include the use of supports having a regular structure such as a ceramic honeycomb, a metal honeycomb, or a metal foam, as the physical support of the catalyst, with all of the components of the catalyst loaded onto the regular structure of the support to form a monolithic catalyst. Geometric optimization of the regularly structure of the catalyst can: (i) provide a lower resistance to the reactants and a lower pressure drop in the reactor, which is beneficial for high space velocity operation and high production intensity; and (ii) improve the mechanical and thermal stability of the catalyst, reducing catalyst abrasion, pulverization and loss of catalyst components caused by operation in the non-steady state. Meanwhile, compared with the catalyst in pellet form, a monolithic catalyst has a lower heat capacity, which is beneficial for fast startup and shutdown of the reaction. In certain embodiments of the present invention, the monolithic catalyst is formed by loading a colloidal sol or an aqueous slurry comprising Ce and another lanthanide or another transition metal onto a monolithic support, followed by loading the aqueous solutions of the precursors for the alkali metal or alkaline earth metal oxide first additives and the catalytic active component of the precious metal, in sequence, onto the support of the catalyst. In certain embodiments, the CeO₂-based composite oxide is loaded using a sol, where the colloidal sol comprising Ce, another lanthanide and/or another transition metal is prepared using the sol-gel method, steps of which have been described supra. In certain more advantageous embodiments, the CeO₂-based composite oxide is loaded using an aqueous slurry, where the aqueous slurry comprising Ce, another lanthanide and/or another transition metal consists of a powder of the CeO₂-based composite oxide, colloidal sol of CeO₂-based composite oxide, and nitric acid at certain desired proportions thereof. The powder of the CeO₂-based composite oxide in the aqueous slurry can be prepared using the method of homogeneous precipitation, the microemulsion method, or the method of co-precipitation as described above. Similarly, each step of the loading process of the catalytic components can be repeated until the required load is reached. The catalyst is preferably reduced such that the previous metal(s) is in elemental state when used.

The following is an illustration of the means of implementation of the present invention using specific examples. One skilled in the art should understand other characteristics and advantages of the present invention from the disclosure in the specification. The present invention may also be implemented or applied through other examples. In addition, various details in the specification may also be modified or changed for different purposes and applications, without departing from the spirit and scope of the present invention.

### EXAMPLES

At least part of the experimental results of the examples of the present invention are shown in the appended drawings. The meanings of the reference symbols in all of the appended drawings are as follows:

S-i indicates the sample number. Thus, S-1 stands for Sample-1, S-10 stands for Sample-10, S-20 stands for Sample-20, and so on. C-i stands for the comparative sample number. Thus, C-1 stands for Comparative Sample-1, C-5 stands for Comparative Sample-5, and so on. CCH4(%) stands for methane conversion rate (%), CCO(%) stands for the concentration (%) of carbon monoxide, and tt (hr) stands for the time (hr). INT (a.u.) stands for the strength of the diffraction peak signals in the XRD diagram. T(° C.) stands for the temperature (° C.). SIG stands for the response value. DA(Å) stands for the pore diameter (A), PA stands for Powder A, PB stands for Powder B, PC stands for Powder C, and CRN stands for a commercially available Ce—Zr oxide powder. ABS (d) stands for adsorption strength (d). RC stands for the catalyst in reduced state, and OC stands for the catalyst in oxidized state. CSNG (%) stands for the conversion rate of simulated natural gas (%).

### Example 1

### Preparation of a CeO₂-Based Composite Oxide Powder

(1-1) Preparation of a Ce—Zr Composite Oxide (Ce/Zr Mole Ratio 1/1) Using the Method of Homogeneous Precipitation

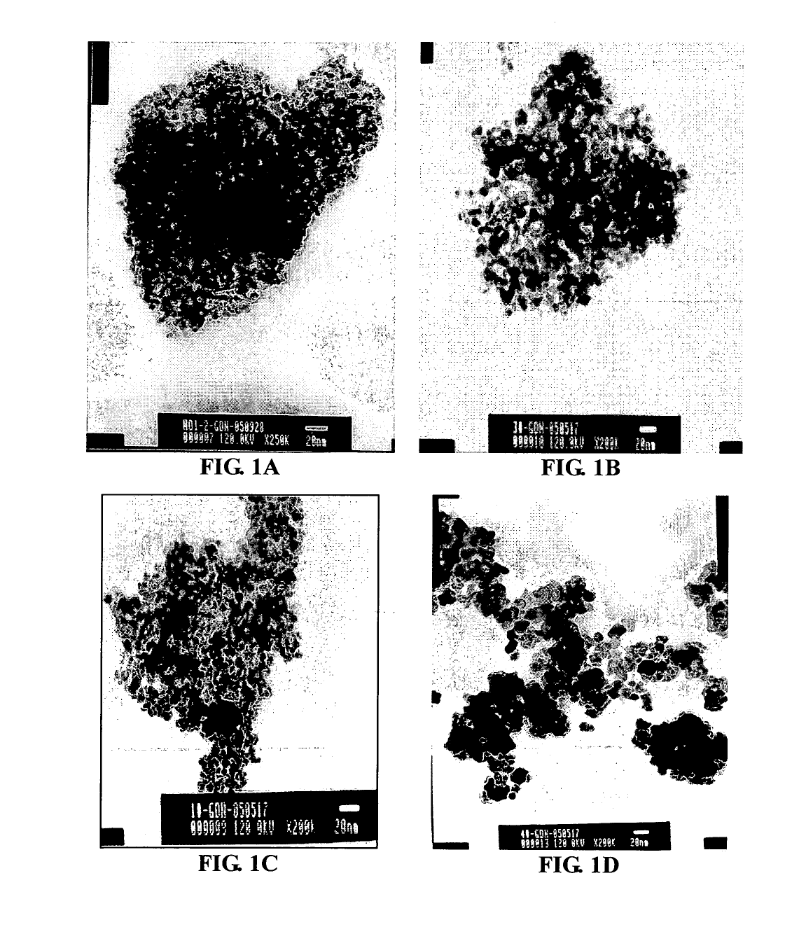

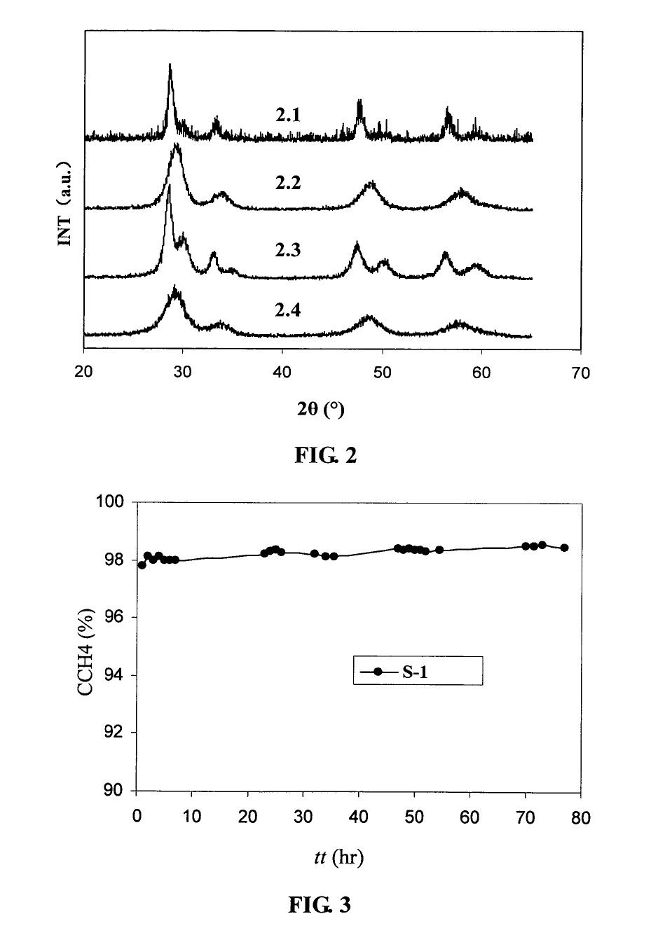

54.823 g of (NH₄)₂Ce(NO₃)₆, 42.914 g of Zr(NO₃)₄.5H₂O, and 180 g of urea were dissolved in 1500 ml of deionized water to form an aqueous mixture solution. The solution was then heated with stirring until urea decomposed. After a precipitate was formed, it was then stirred and boiled (100° C.) for 2 hours, then heating was stopped and stirring continued for 2 hours. The precipitate prepared was suctioned and filtered. The filter cake thoroughly washed in 750 ml of stirred boiling water twice. After each washing, 500 ml of deionized water was added for filtering again. After being washed and filtered twice using deionized water, 150 ml of isopropanol was directly poured over the filter cake, then isopropanol was completely filtered off. The precipitate obtained was dried in a vacuum dryer at 60° C. for over 20 hours, then heated in a muffle furnace at a temperature elevation rate of 2.5° C./min until reaching 500° C., where it was calcined over 2 hours. 29.321 g of a Ce—Zr composite oxide powder was prepared, and labeled as Powder A. BET specific-surface-area testing, as well as transmission electron microscope (TEM) and X-ray diffraction (XRD) characterization showed the specific surface area was 120.4 m²/g, the particle size was approximately 6-7 nm, and there were no characteristic ZrO₂ diffraction peaks (2θ: 29.715°, 34.631°, 49.611°, 59.219°, and 61.66° in the XRD spectrum, indicating that ZrO₂ had completely entered the crystal lattice of CeO₂, and that CeO₂ and ZrO₂ had formed a single-phase solid solution. See FIG. 1A and Curve 2.4 in FIG. 2.

Using 43.447 g of Ce(NO₃)₃.6H₂O as the precursor of Ce in place of 54.832 g of (NH₄)₂Ce(NO₃)₆ in the preparation process described above, following the same preparation process, 29.591 g of a Ce—Zr composite oxide powder was prepared, and labeled as Powder B. BET, TEM, and XRD characterization showed the specific surface area of the powder was 106.3 m²/g, the particle size was approximately 10-12 nm, and there was a characteristic diffraction peak of ZrO₂ in the XRD spectrum, indicating that CeO₂ and ZrO₂ had not completely formed a single-phase solid solution. See FIG. 1B and Curve 2.3 in FIG. 2.

(1-2) Preparation of Ce—Zr Composite Oxide (Ce/Zr Mole Ratio 1/1) Using the Microemulsion Method

21.711 g of Ce(NO₃)₃.6H₂O and 21.46 g of Zr(NO₃)₄.5H₂O were dissolved in deionized water to obtain 100 ml solution (labeled as Solution A). 50 ml of aqueous ammonia at 25 wt % was diluted to 100 ml to obtain a 7.5M solution of aqueous ammonia (labeled as Solution B). 100 ml of polyoxyethylene octylphenyl ether (NP-10) and 120 ml of n-hexanol were added to 400 ml of cyclohexane, then stirred until the mixture solution was clear (labeled as Solution C). Solution A and Solution C described above were then mixed and stirred until clear, and an aqueous emulsion containing Ce, Zr, surfactant, co-surfactant, and oil-phase solvent was obtained. Similarly, Solution B and Solution C described above were mixed and stirred until clear, and an aqueous emulsion containing aqueous ammonia, surfactant, co-surfactant, and oil-phase solvent was obtained. The Ce—Zr microemulsion and the aqueous ammonia microemulsion prepared above were mixed and allowed to react with stirring for 0.5 hour, with the reaction taking place inside the microemulsion doplets. The precipitate formed was heated and refluxed in 70° C. water bath for 10 minutes to break the emulsion, then it was taken out and poured into a Bücher funnel and kept for 1 hour, so that the oil phase and the aqueous phase completely separated. The aqueous phase after separation was dried in a vacuum dryer at 70° C. for 20 hours, then heated in a muffle furnace at a temperature elevation rate of 2.5° C./min until reaching 500° C., where it was calcined for over 2 hours. 12.235 g of a Ce—Zr composite oxide powder was obtained, and labeled as Powder C. BET, TEM, and XRD characterization showed the specific surface area of the powder was 144 m²/g, the particle size was approximately 6-7 nm, and there were no characteristic ZrO₂ diffraction peaks in the XRD spectrum, indicating that CeO₂ and ZrO₂ had completely formed a single-phase solid solution. See FIG. 1C and Curve 2.2 in FIG. 2.

(1-3) Preparation of a Ce—Zr Composite Oxide (Ce/Zr Mole Ratio 1/1) Using the Method of Co-Precipitation

43.415 g of Ce(NO₃)₃.6H₂O and 42.857 g of Zr(NO₃)₄.5H₂O were dissolved in deionized water to obtain a 300 ml solution. 100 ml of aqueous ammonia at 25 wt % was diluted in 200 ml of deionized water to obtain a NH₄OH solution to serve as the precipitating agent. The aqueous Ce—Zr mixture solution was added dropwise to the aqueous ammonia solution of, with stirring, at the rate of 1.5 seconds/droplet, until the pH value was lower than 9. The resultant mixture containing a precipitate was then thoroughly stirred for 2 hours, suctioned and filtered, and the filter cake was washed using 1200 ml of deionized water for 3 times; the washed filter cake was placed in a vacuum dryer at 70° C. for 20 hours, then heated in a muffle furnace at a temperature elevation rate of 2.5° C./min until reaching 500° C., where it was calcined for over 2 hours. 27.104 g of a Ce—Zr composite oxide powder was obtained, and labeled as Powder D. BET, TEM, and XRD characterization showed the specific surface area of the powder was 105.2 m²/g, the particle size was approximately 12-15 nm, and a slight ZrO₂ characteristic diffraction peak was visible in the XRD spectrum, indicating that CeO₂ and ZrO₂ had not completely formed a single-phase solid solution, and that separate phases had begun to appear. See FIG. 1D and Curve 2.1 in FIG. 2.

### Example 2

### Preparation of a CeO₂-Based Composite Oxide Colloidal Sol

85.8 g of Zr(NO₃)₄.5H₂O was dissolved in deionized water to obtain 100 ml 2M Zr(NO₃)₄ solution. 86.8 g of Ce(NO₃)₃.6H₂O was dissolved in the 100 ml of Zr(NO₃)₄ solution described above, and the solution was filtered after mixing. 32 ml of 25% aqueous ammonia was added dropwise into the Ce—Zr mixture solution described above, with stirring, at a rate of 1.5 seconds/droplet, until a Ce—Zr hydroxide gel was formed. Next, 90 ml of 2M HNO₃ was added dropwise to disintegrate the gel, at a rate of 5 seconds/droplet, until the colloid was clear, then the colloid was stirred continuously for 8 hours, whereby 260 ml of a colloidal sol containing the Ce—Zr composite oxide having a Ce/Zr mole ratio of 1/l was prepared.

### Example 3

### Preparation of a Rh/MgO/Ce_{0.5}Zr_{0.5}O₂ Catalyst in the Pellet Form

12.365 g of Powder A from Example (1-1) described above was ground to a particle size of below 75 μm; 2 ml of diluted nitric acid of 12.5% in concentration and 0.6 g of hydrated alumina (Al₂O₃.H₂O) were added. The blended wet powder was extruded into a 2 mm diameter cylindrical bar using an extruder. After the cylindrical bar prepared was dried at 120° C. for 2 hours, then calcined at 750° C. for 2 hours, it was ground to 0.8-1.0 mm pellets to serve as the physical support of the catalyst.

4.152 g of the 0.8-1.0 mm Ce_{0.5}Zr_{0.5}O₂ pellets described above was impregnated with 1.1 ml of a 2.7M Mg(NO₃)₂ solution by incipient wetness impregnation method, dried at 120° C. for 2 hours, and calcined at 750° C. for 2 hours, whereby a MgO-loaded intermediate of the catalyst was prepared. The intermediate was then impregnated by incipient wetness impregnation method with 1.1 ml of RhCl₃ solution with a 10 mg/ml Rh content, dried at 120° C. for 2 hours, and calcined at 900° C. for 2 hours, whereby a catalyst in the oxidized state was prepared. The catalyst described above was reduced at 700° C. for 2 hours using a gas mixture of 10% H₂-90% N₂, and Sample-1 of the catalyst comprising the precious metal in elemental state and having a composition 32% Rh/2.77% MgO/96.91% Ce_{0.5}Zr_{0.5}O₂ was prepared.

Reduction and assessment of the catalyst were both conducted in a lab fixed-bed reactor at atmospheric pressure. Catalyst was packed inside a quartz tube reactor, heated externally using an electric heater. Water was heated and gasified, then mixed with methane and air as feed gas entering the reactor. When the O₂/C ratio in the feed gas was set at approximately 0.46 and the H₂O/C ratio at approximately 2.0, and when the reaction temperature (indicated by T) was approximately 800° C., the reaction could substantially maintain operation authothermally. These conditions for assessment were applied to all of the catalysts in the following examples and comparative examples. However, for the sake of convenience of comparison, different reaction space velocities may be used.

For the assessment results of catalyst Sample-1, with a methane space velocity GHSV of 5000 hr⁻¹, see FIG. 3.

### Example 4

### Preparation of a Rh/MgO/Ce-M-O/α-Al₂O₃ Catalyst in Pellet Form

M in the general formula Ce-M-0 above is another lanthanide rare earth metal or a transition metal element other than cerium, and the Ce/M mole ratio is 1/1.

Commercially available 0.8-1.0 mm γ-Al₂O₃ pellets were calcined at 1100° C. in a muffle furnace for 2 hours, whereby they were transformed into α-Al₂O₃ as the support of the catalyst. Water absorption rate, percentage of the amount of water adsorbed relative to the total weight of the support, of α-Al₂O₃ was found to be 45%.

Ce(NO₃)₃.6H₂O and Zr(NO₃)₄.5H₂O were dissolved in deionized water, to prepare respectively a 1.25M Ce-containing solution and a 1.25 M Zr-containing solution; the two solutions were thoroughly mixed at the Ce/Zr mole ratio of 1/1 and filtered, ready for use.

10.236 g of α-Al₂O₃ support described above was impregnated with 4.5 ml of the aqueous Ce—Zr mixture solution by incipient wetness impregnation method, dried at 120° C. for 2 hours, and calcined at 750° C. for 2 hours, whereby an intermediate of the catalyst impregnated with the Ce—Zr composite oxide was prepared. This process was repeated until the required load of Ce—Zr composite oxide was obtained. The intermediate of the catalyst described above was then impregnated with 4.3 ml of 2.7M Mg(NO₃)₂ solution by incipient wetness impregnation method, dried at 120° C. for 2 hours, and calcined at 750° C. for 2 hours, whereby a catalyst intermediate impregnated with Ce—Zr composite oxide and MgO was prepared. Finally, 4.2 ml of the RhCl₃ solution with a 10 mg/ml Rh content was impregnated onto the catalyst intermediate obtained above by incipient wetness impregnation method, followed by drying at 120° C. for 2 hours and then calcined at 900° C. for 2 hours, whereby a catalyst in the oxidized state was prepared. The catalyst described above was reduced at 700° C. for 2 hours using the gas mixture of 10% H₂-90% N₂, whereby Sample-2 of the catalyst comprising precious metal in elemental state and having a composition of 0.32% Rh/3.51% MgO/18.82% Ce.Zr.O₂/77.36% α-Al₂O₃ was prepared.

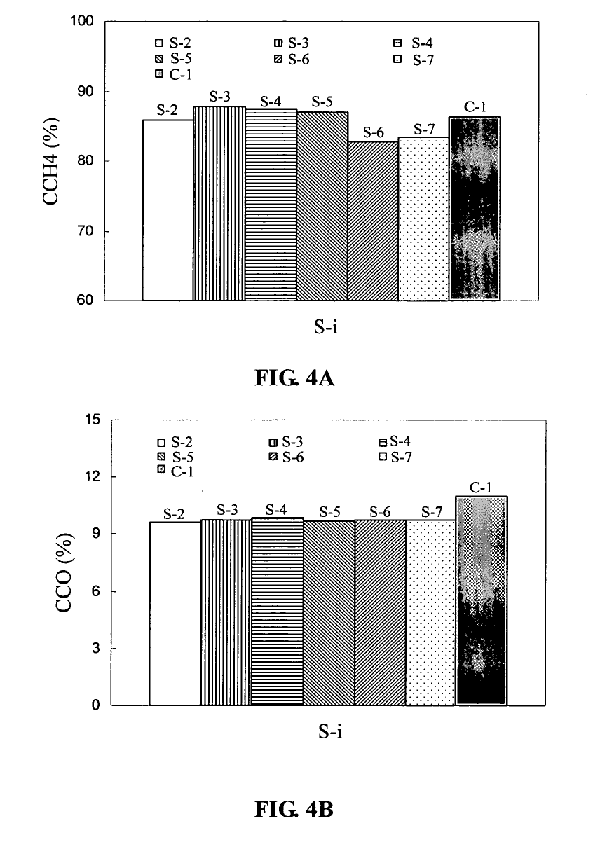

A series of Rh/MgO/Ce-M-O/α-Al₂O₃ catalysts in pellet form were prepared using the same preparation steps described above, wherein M is another lanthanide rare earth metal or a transition metal element other than cerium, and the Ce/M mole ratio is 1/1. For the composition of the samples prepared, see Table 1 below. Meanwhile, in order to highlight the advantages of these embodiments of the present invention, a comparative catalyst example, Rh/MgO/α-Al₂O₃, was prepared and is also included in Table 1. For performance assessment results of the catalysts described above, see FIGS. 4A and 4B. From FIGS. 4A and 4B, it can be seen that the catalyst samples according to these embodiments of the present invention can effectively reduce CO content in the reformate gas while maintaining a fairly high methane conversion rate.

TABLE 1
Compositions of a series of Rh/MgO/Ce-M-O/α-Al₂O₃
catalysts in pellet form and a comparative example

| Sample No. | Composition, % |
|---|---|
| Sample-2 | 0.30%Rh/3.51%MgO/18.84%Ce—Zr—O/77.35%α-Al₂O₃ |
| Sample-3 | 0.31%Rh/3.29%MgO/18.26%Ce—La—O/78.14%α-Al₂O₃ |
| Sample-4 | 0.32%Rh/3.41%MgO/18.63%Ce—Sm—O/77.64%α-Al₂O₃ |
| Sample-5 | 0.33%Rh/3.52%MgO/18.89%Ce—Gd—O/77.26%α-Al₂O₃ |
| Sample-6 | 0.30%Rh/3.54%MgO/17.96%Ce—Zr—La—O/78.20%α-Al₂O₃ |
| Sample-7 | 0.32%Rh/3.36%MgO/19.32%Ce—O/77.00%α-Al₂O₃ |
| Comparative sample-1 | 0.33%Rh/3.56%MgO/96.12%α-Al₂O₃ |

### Example 5

### Preparation of a Rh/M-O/Ce—Zr—O/α-Al₂O₃ Catalyst in Pellet Form

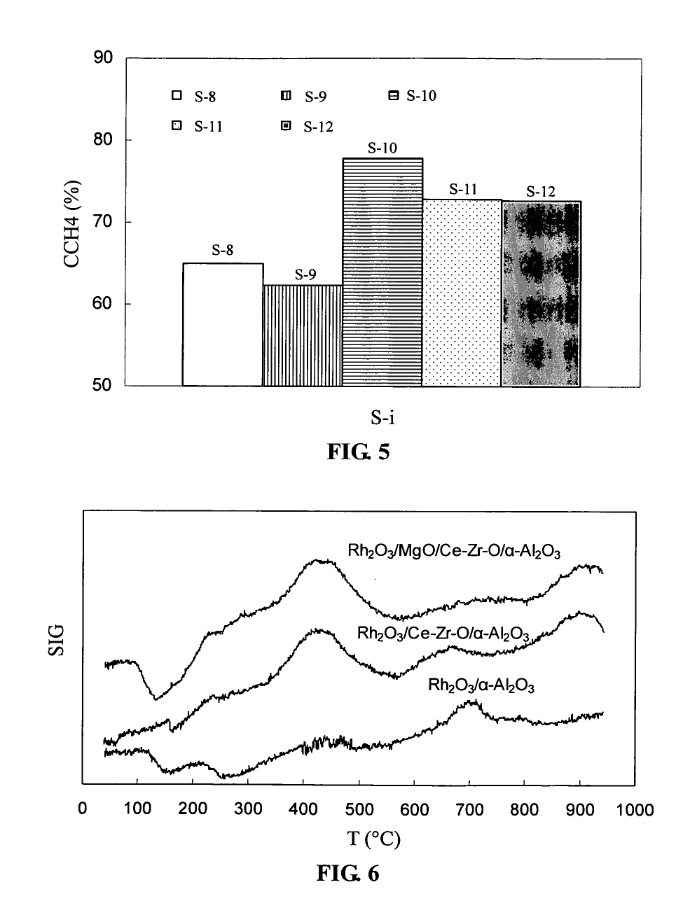

M in the general formula described above is an alkali metal or alkaline earth metal element—K, Mg, or Ca. The method used to prepare the catalyst was the same as in Example 3. The aqueous solution of a nitrate of K, Ca, or Mg, and Mg(NO₃)₂ solutions with different concentrations were selected as the precursor of the additive of the alkali metal and alkaline earth metal oxides. RhCl₃ solution with a 5 mg/ml Rh content was selected for precious metal impregnation. For the composition of the samples prepared, see Table 2 below. For performance assessment results of the catalysts described above, see FIG. 5. From FIG. 5, it can be seen that, within the studied range, the performance of the catalyst comprising 2.16% MgO additive had superior performance.

TABLE 2
Compositions of a series of Rh/M-O/Ce—Zr—O/α-Al₂O₃
catalysts in pellet form

| Sample No. | Composition, % |
|---|---|
| Sample-8 | 0.15%Rh/2.23%K₂O/18.12%Ce—Zr—O/79.50%α-Al₂O₃ |
| Sample-9 | 0.16%Rh/2.17%CaO/18.34%Ce—Zr—O/79.33%α-Al₂O₃ |
| Sample-10 | 0.15%Rh/2.16%MgO/18.25%Ce—Zr—O/79.44%α-Al₂O₃ |
| Sample-11 | 0.15%Rh/4.12%MgO/18.65%Ce—Zr—O/77.08%α-Al₂O₃ |
| Sample-12 | 0.16%Rh/1.25%MgO/18.96%Ce—Zr—O/79.63%α-Al₂O₃ |

### Example 6

### H₂-TPR Characterization of Catalysts in Pellet Form

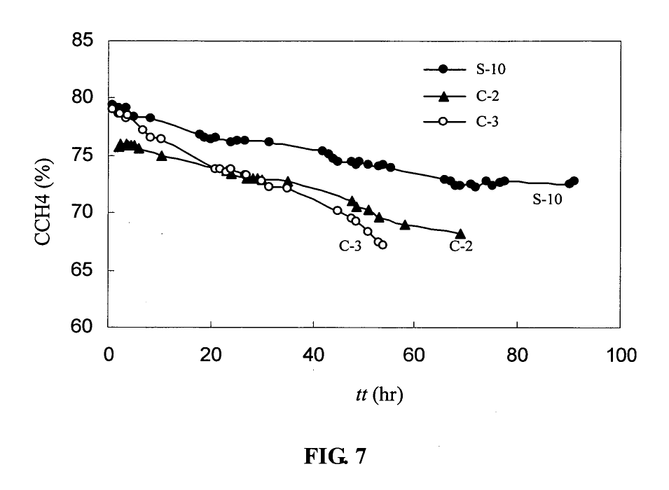

Results of temperature programmed reduction (H₂-TPR) characterization of the pellet catalyst samples in Table 3 are provided in FIG. 6 to show the effect of adding the CeO₂-based composite oxide additive and the alkali metal and/or alkaline earth metal oxide additive to the catalyst. For performance assessment results of the corresponding catalysts, see FIG. 7. It can be seen from FIG. 6 that the addition of MgO and Ce—Zr composite oxide had impact on the Rh₂O₃/α-Al₂O₃ TPR profile. This indicates that new species were formed. In the TPR spectrum of Rh₂O₃/α-Al₂O₃, a weak Rh₂O₃ reduction peak at approximately 200° C. was observed. A high temperature reduction peak was observed at about 700° C. The strong interaction between Al and Rh oxides (especially the formation of RhAlO₃) was responsible for the peak. The relatively wide TPR peak observed between 300-500° C. might be due to various interactions between Rh and Al.

In the TPR spectrum of the Rh₂O₃/Ce—Zr—O/α-Al₂O₃ catalyst, the reduction peak at 700° C. shifted to the lower temperature by 20° C. This may be because the interaction between Rh and the α-Al₂O₃ support was weakened, while a new interaction between Rh and the Ce—Zr composite oxide occurred. It was reported that the reduction temperature for of the surface phase of the Ce—Zr composite oxide was in the range of 450-650° C., while that for the bulk phase was approximately 900° C. If CeO₂ and ZrO₂ had not completely formed into a solid solution, the reduction peak of H₂-TPR may still have been at 700° C. When the Ce—Zr composite oxide was loaded with an active component, the peak at 450-650° C. should shift towards lower temperature. Therefore, in the Rh₂O₃/Ce—Zr—O/α-Al₂O₃ TPR spectrum, the reduction peak at 900° C. belongs to the bulk-phase reduction peak of the Ce—Zr oxide. The wide peak at 200-560° C. was very likely a reduction peak produced due to the interaction of Ce—Zr oxide and Rh. The reduction peak at 680° C. indicated that, on the catalyst in pellet form, CeO₂ and ZrO₂ had not completely formed into a solid solution. The interaction of Rh with Ce—Zr—O greatly enhanced the oxidation and reduction performance of the Ce—Zr composite oxide, therefore compared with a catalyst without added Ce—Zr—O, the activity and stability of the catalyst were enhanced (see FIG. 7).

Furthermore, when MgO was added to the Rh₂O₃/Ce—Zr—O/α-Al₂O₃ catalyst, the reduction peak 680° C. became weaker and the 200-560° C. reduction peak became stronger with an even more pronounced profile in the range of 200-350° C. It is reported that the formation of spinel-structured MgRh₂O₄ can result in a reduction peak in the range of 250-400° C. The interaction between Rh and Mg could further enhance the stability and reforming activity of the catalyst. The performance assessment results of the catalysts in FIG. 7 are consistent with the TPR characterization.

TABLE 3
Compositions of sample catalysts in pellet form characterized by H₂-TPR

| Sample No. | Composition, % |
|---|---|
| Sample-10 | 0.15%Rh/2.16%MgO/18.25%Ce—Zr—O/79.44%α-Al₂O₃ |
| Comparative Sample-2 | 0.14%Rh/18.37%Ce—Zr—O/81.49%α-Al₂O₃ |
| Comparative sample-3 | 0.16%Rh/98.40%α-Al₂O₃ |

### Example 7

### Preparation of a Rh/MgO/Ce_{0.5}Zr_{0.5}O₂/Cordierite Ceramic Honeycomb Catalyst

A precut cordierite ceramic honeycomb support (pore density 400 pores/square inch, 400 cpsi) was pre-treated using a 3% nitric acid solution, washed clean using deionized water, then dried at 120° C. for 2 hours, and calcined at 900° C. for 2 hours, ready to be used.

12 g of Ce—Zr composite oxide Powder A, 17 ml of Ce—Zr colloidal sol with a 1/1 Ce/Zr mole ratio, and 5 ml of HNO₃ solution at a pH of 1.2 were mixed with 10 ml of deionized water, ball milled using a wet ball miller for 12 hours, to obtain an aqueous slurry containing the Ce—Zr composite oxide. The pH of the slurry prepared was adjusted to the range of 3.5-4.0 using an appropriate amount of deionized water and HNO₃ solution (pH value of 1.2). About 50 ml of the Ce—Zr aqueous slurry for impregnating the honeycomb support was prepared.

0.7448 g ceramic honeycomb support was immersed in the Ce—Zr slurry described above, with appropriate stirring of the slurry; 3 minutes after the immersion, the honeycomb was taken out, the excess slurry in the channels of the ceramic honeycomb was purged using compressed air, then the coated honeycomb support described above was rapidly microwave-dried for 3 minutes. The honeycomb was then calcined at 750° C. in a muffle furnace for 2 hours and a catalyst intermediate with a 0.085 g Ce_{0.5}Zr_{0.5}O₂ load was obtained. The process was repeated 8 times and a catalyst intermediate with a 0.602 g Ce_{0.5}Zr_{0.5}O₂ load was obtained. The catalyst intermediate obtained was then immersed in 50 ml 2.7M Mg(NO₃)₂ solution. The catalyst intermediate was loaded with 0.035 g of MgO by the same method. Afterwards, again using the same method described above, the MgO-loaded catalyst intermediate was loaded with Rh₂O₃; the impregnation solution used was 50 ml of RhCl₃ solution containing 23 mg/ml Rh. After microwave-drying and calcination at 750° C. for 2 hours, a ceramic honeycomb catalyst with the precious metal in oxidized state was obtained; and the sample number was Sample-13. The catalyst described above was reduced at 700° C. for 2 hours using a 10% H₂-90% N₂ gas mixture, thereby a catalyst comprising elemental precious metal was obtained with a composition of 0.33% Rh/2.52% MgO/43.42% Ce_{0.5}Zr_{0.5}O₂/53.70% cordierite.

Sample-14 and Sample-15 of the catalysts listed in Table 4 were prepared using the same method described above. With aqueous slurries containing Al₂O₃, TiO₂, ZrO₂, and CeO₂ in place of the Ce—Zr aqueous slurry described above, and using the same preparation steps described above, Comparative Sample-4 to Comparative Sample-8 listed in Table 4 were prepared respectively. Aqueous slurries containing Al₂O₃, TiO₂, ZrO₂, and CeO₂ were prepared from 12 g of the oxide powder, and 5 ml of HNO₃ solution at a pH of 1.2 was mixed respectively with 10 ml of deionized water, then ball milled using the method of wet ball milling for 12 hours.

TABLE 4
Compositions of Rh/MgO/Ce_{0.5}Zr_{0.5}O₂/cordierite monolithic
ceramic honeycomb catalysts and comparative examples

| Sample No. | Composition, % |
|---|---|
| Sample-13 | 0.33%Rh/2.52%MgO/43.42%Ce_{0.5}Zr_{0.5}O₂/53.70% cordierite |
| Sample-14 | 0.35%Rh/2.52%MgO/32.41%Ce_{0.5}Zr_{0.5}O₂/64.72% cordierite |
| Sample-15 | 0.43%Rh/3.08%MgO/19.26%Ce_{0.5}Zr_{0.5}O₂/77.23% cordierite |
| Comparative Sample-4 | 0.34%Rh/2.81%MgO/33.56%Al₂O₃/63.29% cordierite |
| Comparative Sample-5 | 0.36%Rh₃/2.64%MgO/32.03%TiO₂/64.97% cordierite |
| Comparative Sample-6 | 0.34%Rh/2.39%MgO/32.92%ZrO₂/64.35% cordierite |
| Comparative Sample-7 | 0.34%Rh/2.51%MgO/34.63%CeO₂/62.52% cordierite |
| Comparative Sample-8 | 0.41%Rh/3.87%MgO/95.72% cordierite |

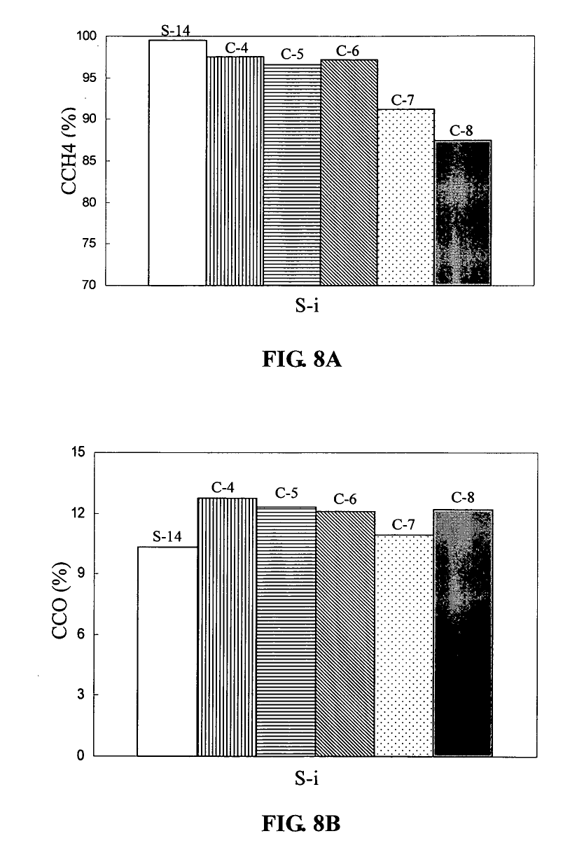

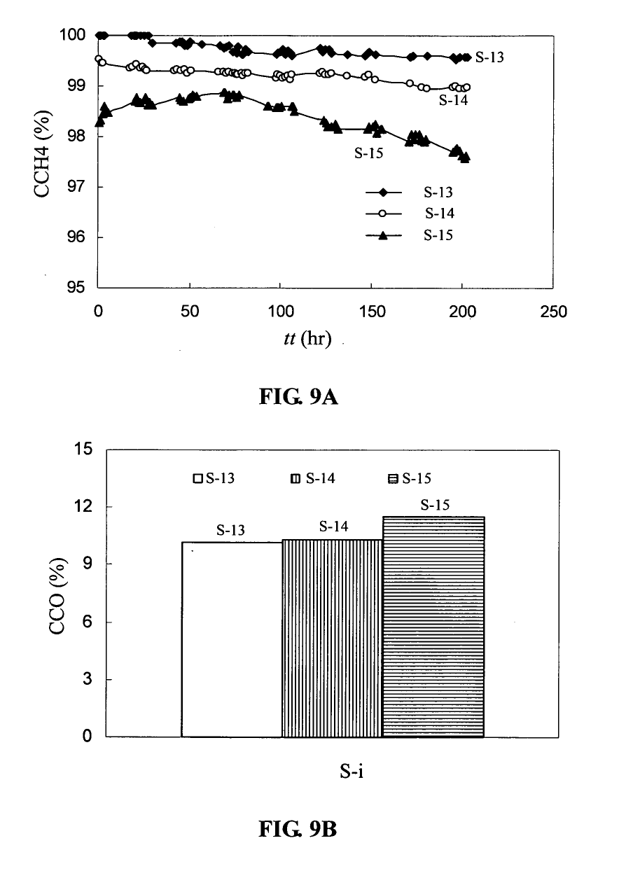

See FIGS. 8A, 8B, 9A and 9B for the performance assessment results of the catalysts described above. FIG. 8A is a bar chart showing and comparing the different methane conversion rates of a series of catalysts according to certain embodiments of the present invention comprising Ce_{0.5}Zr_{0.5}O₂ as an additive, as well as certain catalysts not according to the prevent invention (Rh/MgO/M-O/cordierite) comprising an oxide such as Al₂O₃, TiO₂, ZrO₂, CeO₂ as an additive. FIG. 8B is a bar chart showing and comparing the CO concentrations in different reformate gases corresponding to the catalysts in FIG. 8A (GHSV=5000 hr⁻¹, O₂/C=0.46, H₂O/C=2.0, T=800° C.). From FIGS. 8A and 8B, the effects of the additive of Ce_{0.5}Zr_{0.5}O₂ oxides were exhibited by not only an enhancement of the catalytic activity, but also an effective reduction of CO content in the reformate gas. This result is consistent with FIG. 4 of the catalysts in pellet form. Adding CeO₂ could also help to maintain CO content in the reformate gas at a lower level, but unfortunately long-term stability of the catalyst was relatively poor. FIG. 9A is a bar chart showing and comparing the different methane conversion rates of a series of catalysts containing different amounts of Ce_{0.5}Zr_{0.5}O₂ (Rh/MgO/Ce_{0.5}Zr_{0.5}O₂/cordierite). FIG. 9B is a bar chart showing and comparing the CO concentration in different reformate gases corresponding to the catalysts in FIG. 9A (GHSV=5000 hr⁻¹, O₂/C=0.46, H₂O/C=2.0, T=800° C.). From FIGS. 9A and 9B, it can be seen that the content of Ce_{0.5}Zr_{0.5}O₂ had great effects on long-term stability of the catalyst and on CO content in the reformate gas. The higher the content of Ce_{0.5}Zr_{0.5}O₂, the more stable the catalyst, and the lower the CO content in the reformate gas.

### Example 8

### Preparation of Rh/MgO/Ce—Zr—O/Cordierite Monolithic Ceramic Honeycomb Catalysts Using Ce—Zr Composite Oxides Prepared by Different Preparation Methods

The method used to prepare the catalyst by impregnation with aqueous slurry containing Ce—Zr composite oxide was essentially identical as in Example 7, with the exception that Ce—Zr composite oxide Powders B, C, and D in Examples (1-1) to (1-3) were used in place of Powder A. The compositions of the Rh/MgO/Ce—Zr—O/cordierite ceramic honeycomb catalysts prepared are listed in Table 5 below.

The method used to prepare the catalyst by impregnation with aqueous Ce—Zr colloidal sol was essentially identical as in Example 7, with the exception that the Ce—Zr colloidal sol prepared in Example 2 was used in place of the aqueous slurry in Example 7 for catalyst impregnation. Compositions of the catalysts prepared are also listed in Table 5 below.

TABLE 5
Compositions of Rh/MgO/Ce—Zr—O/cordierite ceramic honeycomb catalysts
(with different Ce—Zr composite oxide preparation method)

| Sample | Composition, % | Preparation method |
|---|---|---|
| Sample-14 | 0.35%Rh/2.52%MgO/32.41%Ce_{0.5}Zr_{0.5}O₂/64.72% cordierite | Powder A |
| Sample-16 | 0.34%Rh/2.85%MgO/33.66%Ce—Zr—O/63.15% cordierite | Powder B |
| Sample-17 | 0.36%Rh/3.08%MgO/30.65%Ce_{0.5}Zr_{0.5}O₂/65.91% cordierite | Powder C |
| Sample-18 | 0.34%Rh/2.61%MgO/32.89%Ce—Zr—O/64.16% cordierite | Powder D |
| Sample-19 | 0.35%Rh/2.67%MgO/31.42%Ce—Zr—O/65.56% cordierite | Sol-gel method |

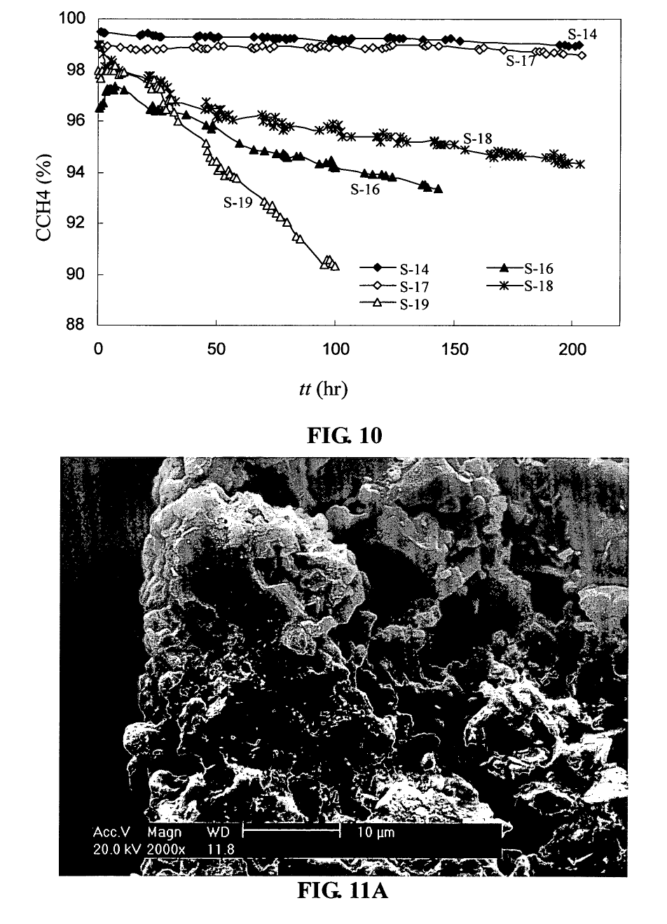

See FIG. 10 for the performance assessment results of the catalysts. From this figure, it can be seen that there is a large stability difference between catalysts prepared using different Ce—Zr composite oxide preparation methods. Among the samples, Sample-14 and Sample-17, prepared from Powder A and Powder C by impregnation with aqueous slurry, showed superior stability, followed by the catalyst prepared using Powder D. Stability of the catalyst prepared using Powder B is relatively poor. Methane conversion rate of the catalyst prepared using the sol-gel method began to drop 7 hours after the reaction started.

Differences in physical properties of the Ce—Zr composite oxide powders prepared using different methods, particularly with regard to whether CeO₂ and ZrO₂ have formed into a single-phase solid solution, are the major cause of instability differences of the sample catalysts prepared by impregnation with aqueous slurry. Differences in physical properties of Ce—Zr composite oxide powders were described in detail in Example 1.

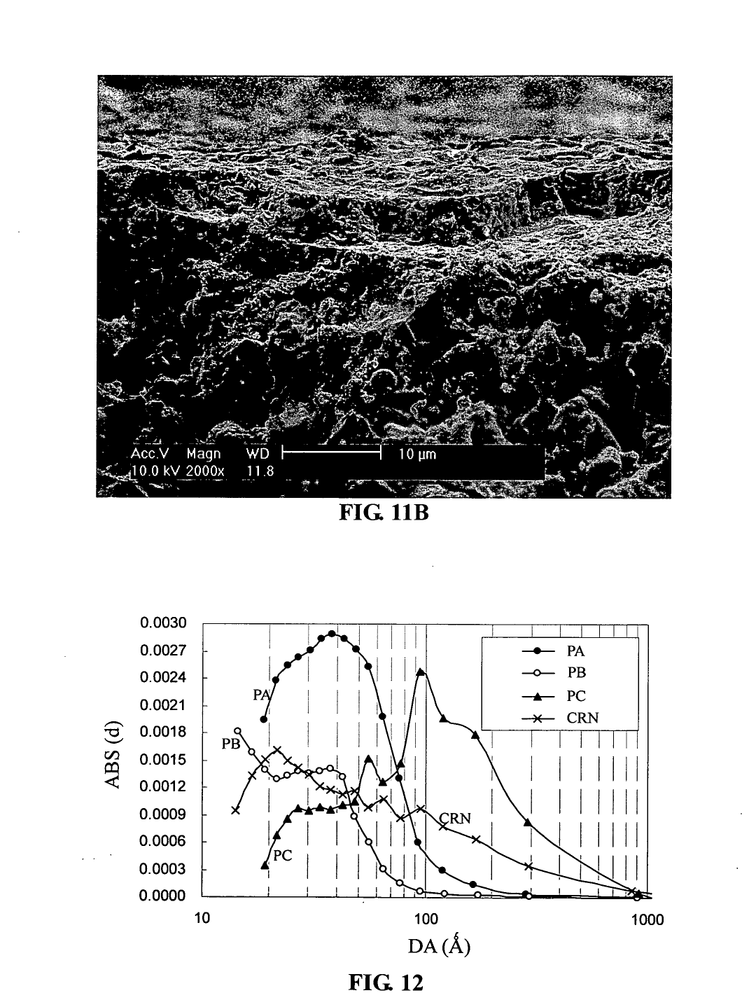

The cause of a stability drop in the catalyst prepared using the sol-gel method is believed to include the particle size of the colloidal sol. Because the particle size of the Ce—Zr colloidal sol (on nm level) is smaller than the wall pore size of the ceramic honeycomb support (on μm level), the sol particles could enter the pore channels of the support. However; slurry impregnation resulted in a surface coating on the ceramic honeycomb support (see the SEM image of the catalyst in FIG. 11), thus the active component Rh was dispersed more on the external surface of channels of the ceramic honeycomb, which is beneficial for catalyst stability.

### Example 9

### Effects of the Distribution of the Pore Size of the Ce—Zr Composite Oxide on Catalyst Stability

BET pore-size distribution characterization of the Ce—Zr composite oxide Powder A, Powder B, and Powder C used in Example 8 are shown in FIG. 12. Meanwhile, a commercially available Ce—Zr composite oxide powder CRN is selected for comparison. The stability of the catalyst prepared using Powder CRN was not good under the experimental conditions of the present application. From FIG. 12, it can be seen that Powder A and Powder C, from which catalysts with high stability were prepared, had a larger pore size, while the pore size of Powder B and Powder CRN, whose performances were less than good, was smaller. This difference may also be the reason for stability difference between the catalysts. Because the methane ATR process is controlled by internal diffusion, a larger pore size is beneficial for the diffusion in of the reactant and out of the product in the catalyst layer coated on the walls of ceramic honeycomb support, thus maintaining a long-term stability of catalyst activity.

### Example 10

### Preparation of Rh/MgO/Ce—Zr—O/Cordierite Ceramic Honeycomb Catalysts from Ce—Zr Composite Oxides with Differing Ce/Zr Ratios

Using (NH₄)₂Ce(NO₃)₆ and Zr(NO₃)₄.5H₂O as the precursors, and the method of homogenous precipitation described in Example (1-1), Ce—Zr composite oxide powders with their Ce/Zr mole ratios of 4/1, 1/1, and 1/4 were prepared. In addition, using Ce(NO₃)₃.6H₂O and Zr(NO₃)₄.5H₂O as the precursors, the sol-gel method described in Example 2, Ce—Zr composite oxide sols with Ce/Zr mole ratios of 4/1, 1/1, and 1/4 were prepared. Aqueous slurries containing Ce—Zr composite oxides with different Ce/Zr ratios were prepared at the same component proportions and using the same method of ball milling as described in FIG. 7. Further, Rh/MgO/Ce—Zr—O/cordierite ceramic honeycomb catalysts made from composite oxides with differing Ce/Zr ratios were prepared using the same preparation method as in Example 7. Compositions of the catalysts are listed in Table 6 below.

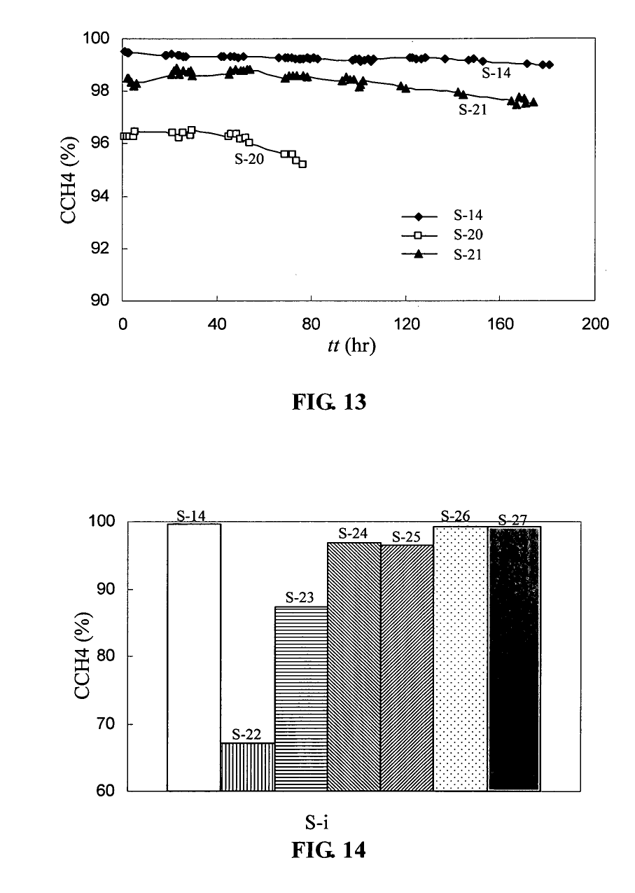

See FIG. 13 for the performance assessment results of the catalysts. From this figure, it can be seen that in addition to slight differences in initial catalyst activity, effects of Ce/Zr ratio in the Ce—Zr composite oxides on catalyst performance is mainly on catalyst stability. Sample-14 of the catalyst, with a Ce/Zr ratio of 1/1, showed superior stability, while the stability of the other two samples was slightly worse. The difference described above can be explained by whether the powders of the Ce—Zr composite oxides with different Ce/Zr ratios have formed single-phase solid solutions, and by the properties of single-phase solid solutions formed. From the results of XRD characterization, it can be seen that samples with a 1/4 Ce/Zr ratio had not completely formed into a CeO₂—ZrO₂ solid solution, and the ZrO₂ species retained the tetragonal ZrO₂ crystalline structure. For samples with a 4/1 Ce/Zr ratio, although most of the Zr⁴⁺ entered the cubic crystalline lattice of CeO₂ to form a solid solution with it, this solid solution was Ce-rich. However, for a sample with a 1/1 Ce/Zr ratio, the solid solution was Zr-rich. It was reported that stability of catalyst activity of Ce-rich solid solution and non-single-phase solid solution (such as microcrystalline mixture of CeO₂ and ZrO₂) is inferior to that of single-phase Zr-rich CeO₂—ZrO₂ solid solution. This is consistent with the experimental results of the present invention.

TABLE 6
Compositions of Rh/MgO/Ce—Zr—O/cordierite
catalysts with different Ce/Zr ratios

| | | Ce—Zr |
|---|---|---|
| Sample No. | Composition, % | proportion |
| Sample-14 | 0.35%Rh/2.52%MgO/32.41%Ce_{0.5}Zr_{0.5}O₂/64.72% cordierite | 1/1 |
| Sample-20 | 0.35%Rh/2.76%MgO/33.63%Ce—Zr—O/63.26% cordierite | 4/1 |
| Sample-21 | 0.32%Rh/2.98%MgO/31.68%Ce—Zr—O/65.02% cordierite | 1/4 |

### Example 11

### Preparation of PGM/MgO/Ce_{0.5}Zr_{0.5}O₂/Cordierite Ceramic Honeycomb Catalysts Comprising Various Precious Metals and Multiple Precious Metals

The preparation steps of were essentially the same as in Example 7, except that during impregnation of the precious metal active component, a PdCl₂ solution or a RuCl₃ solution with a metal concentration of 23 mg/ml (calculated on the basis of the metal in elemental state), a H₂PtCl₆ solution or a H₂IrCl₆ solution with a metal concentration of 12 mg/ml, and precious metal mixture solutions with metal concentrations of (12 mg/ml Rh+6 mg/ml Pt) or (12 mg/ml Rh+6 mg/ml Ir) were used respectively in place of the RhCl₃ solution (with 23 mg/ml Rh) used in Example 7. Compositions of the PGM/MgO/Ce_{0.5}Zr_{0.5}O₂/cordierite ceramic honeycomb catalysts comprising various previous metals are listed in Table 7 below.

See FIG. 14 for the performance assessment results of the catalysts. From this figure, it can be seen that PGM/MgO/Ce_{0.5}Zr_{0.5}O₂/cordierite ceramic honeycomb catalysts prepared using various precious metals of the platinum family, or their combinations and mixtures, had different activities in the methane ATR process, and the activity sequence was: Rh>Rh—Pt≈Rh—Ir>Pt≈Ir>Pd>Ru.

TABLE 7
Compositions of the PGM/MgO/Ce_{0.5}—Zr_{0.5}—O₂/cordierite catalysts prepared
using different precious metals, or their combinations and mixtures

| Sample No. | Composition, % |
|---|---|
| Sample-14 | 0.35%Rh/2.52%MgO/32.41%Ce_{0.5}Zr_{0.5}O₂/64.72% cordierite |
| Sample-22 | 0.37%Ru/3.36%MgO/35.43%Ce_{0.5}Zr_{0.5}O₂/60.84% cordierite |
| Sample-23 | 0.35%Pd/3.16%MgO/33.63%Ce_{0.5}Zr_{0.5}O₂/62.86% cordierite |
| Sample-24 | 0.31%Pt/3.36%MgO/34.76%Ce_{0.5}Zr_{0.5}O₂/61.57% cordierite |
| Sample-25 | 0.34%Ir/2.96%MgO/35.63%Ce_{0.5}Zr_{0.5}O₂/61.07% cordierite |
| Sample-26 | 0.34%Rh—Pt/3.51%MgO/36.73%Ce_{0.5}Zr_{0.5}O₂/59.42% cordierite |
| Sample-27 | 0.32%Rh—Ir/2.99%MgO/34.68%Ce_{0.5}Zr_{0.5}O₂/62.01% cordierite |

### Example 12

### Preparation of Rh/MgO/Ce_{0.5}Zr_{0.5}O₂/Cordierite Catalysts with the Honeycomb Supports Having Different Pore Density Levels

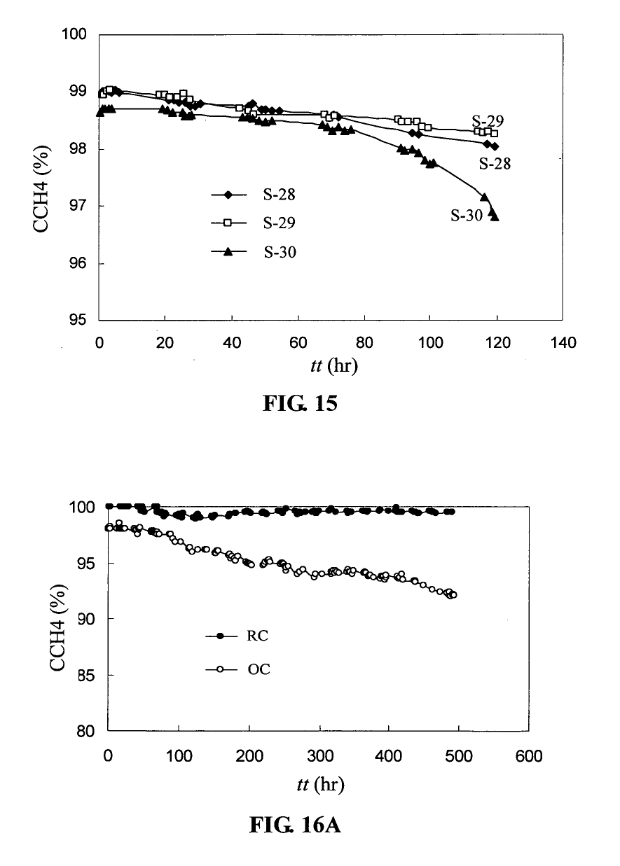

Cordierite ceramic honeycomb with different pore density levels (400 cpsi, 600 cpsi, and 900 cpsi) were pre-cut into support samples having the same shape and volume. Using the same preparation steps as in Example 7, Rh/MgO/Ce_{0.5}Zr_{0.5}O₂/cordierite catalysts with the honeycomb supports having different pore density levels were prepared. Because supports with the same shape and volume but different pore density levels differ in weight, to maintain the comparability of the catalysts, the weight of various active components and additives that the catalysts carry should be consistent. See Table 8 below for the specific compositions of the catalysts. See FIG. 15 for the performance assessment results of the catalysts. From this figure, it can be seen that the stability of the catalyst prepared using a support with a low pore density of 400 cpsi was relatively poor. This is because with the same shape and volume, the support with a low pore density of 400 cpsi had the smallest channel surface area, thus the coating formed on the channel wall carrying the active component of the same weight was the thickest. Therefore, for the methane ATR process, which is controlled by internal diffusion, the usage of the active component was the lowest.

TABLE 8
Compositions of Rh/MgO/Ce_{0.5}Zr_{0.5}O₂/cordierite catalysts prepared
using honeycomb supports with different pore density levels

| Sample No. | Composition, % | Pore density |
|---|---|---|
| Sample-28 | 0.42%Rh/3.62%MgO/34.76%Ce_{0.5}Zr_{0.5}O₂/61.20% cordierite | 900 cpsi |
| Sample-29 | 0.40%Rh/3.29%MgO/30.22%Ce_{0.5}Zr_{0.5}O₂/66.09% cordierite | 600 cpsi |
| Sample-30 | 0.32%Rh/2.51%MgO/22.96%Ce_{0.5}Zr_{0.5}O₂/74.21% cordierite | 400 cpsi |

### Example 13

### Impact of Pre-Reduction of the Catalyst on Catalyst Stability

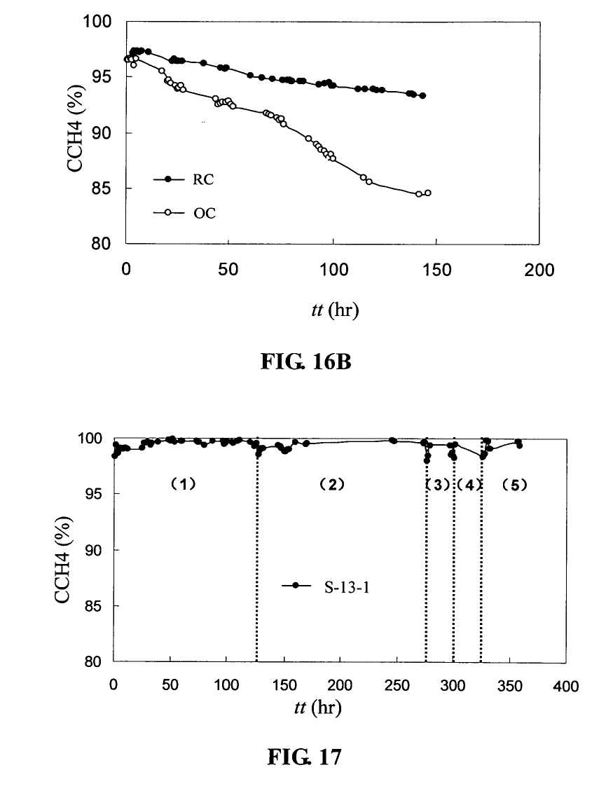

Two groups of parallel samples, Sample-14 and Sample-16, are selected from Example 8. One group was directly subjected to experiments in the form of catalysts in the oxidized state, while the other group was reduced at 700° C. for 2 hours in the reactor using a 10% H₂-90% N₂ gas mixture, before the reaction. See FIG. 16A for the assessment results of the catalysts. The assessment results indicate that the process of reduction could significantly improve the stability of the catalysts. A brown-red Rh oxide sediment was observed on the reactor wall in the experiment of the catalyst without pre-reduction, indicating that the precious metal active component Rh₂O₃ decomposed at high temperature, volatized and deposited on the reactor wall. This phenomenon was not observed in samples of the pre-reduced catalysts. Therefore, pre-reduction of the catalyst is one of the major factors ensuring a long catalyst service life. It can also be seen in FIG. 16B that although pre-reduction could significantly enhance the stability of the catalyst, because the activity of a catalyst prepared from Powder B still gradually decreased after pre-reduction, it was once again proved that whether a single-phase solid solution is formed from the Ce—Zr composite oxide is also one of the major factors affecting catalyst stability.

### Example 14

### Advantageous Results of Certain Embodiments of the Present Invention

A Series of Identical Samples 13 in Example 7 were Prepared and Labeled Sample 13-1, 13-2 and 13-3.

(1) Performance During Startup and Shutdown Reaction Cycles

Sample-13-1 was used. After 5 normal startup and shutdown cycles (that is, all the power supplies were shut off directly after the reaction was over), the activity of the catalyst remained unchanged. This proved that the catalyst of the present invention can be used for methane ATR hydrogen source for fuel cells operating in non-steady modes. See FIG. 17.

(2) Experiment on Long-Term Stability of the Catalyst

Sample-13-2 was used. In a lab fixed-bed reactor, under the following operating conditions:
methane gas hourly space velocity (GHSV): 5000 h⁻¹
O₂/C in the feedstock gas: 0.46
H₂/C in the feedstock gas: 2.0
temperature at the center of reaction bed: 800° C.
reaction pressure: atmospheric,
   a reformate gas having the following dry composition was obtained: 47.48% H₂, 10.48% CO, 8.08% CO₂, and 0.1% CH₄, N₂ balance.

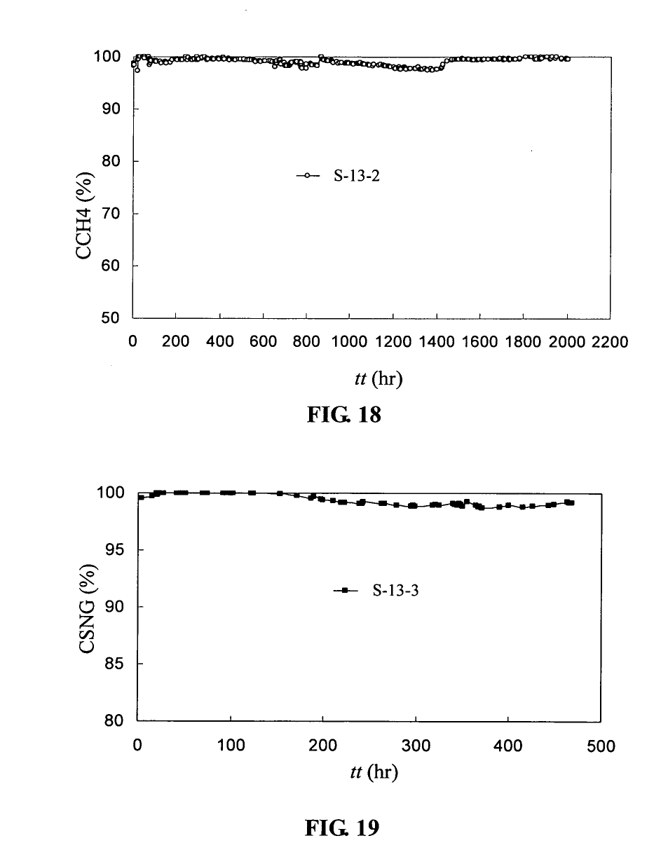

After steady operation for 2000 hours, catalyst activity remained at over 99.5%. See FIG. 18.

(3) Performance of the Catalyst when the Reactant is Simulated Natural Gas

Sample-13-3 was used. Composition of the simulated natural gas for the ATR process was 92% CH₄, 1.2% N₂, 0.3% CO₂, balance C₂-C₅ components. An experiment was carried out in a lab fixed-bed reactor under the following operating conditions:
methane gas hourly space velocity (GHSV): 5000 h⁻¹
O₂/C in the feedstock gas: 0.46-0.48
H₂/C in the feedstock gas: 2.0
temperature at the center of reaction bed: 800° C.
reaction pressure: atmospheric.

A reformate gas having the following dry composition was obtained: 47.07% H₂, 10.00% CO, 8.76% CO₂, and 0.14% CH₄, N₂ balance. After steady operation for 470 hours, catalyst activity remained at about 99.0% and no attenuation was observed. See FIG. 19.

(4) Scaled Ceramic Honeycomb Catalysts

The performance of ceramic honeycomb catalysts according to certain embodiments of the present invention were further tested in the methane ATR hydrogen system for a 10 kW fuel-cell system.

The composition and preparation steps of Sample-13 in Example 7 was used. An amplified ATR catalyst was made. The catalyst was used in the methane ATR hydrogen system for a fuel-cell system, under the following working conditions:
methane gas hourly space velocity (GHSV): 4300 h⁻¹
O₂/C in the feedstock gas: 0.44
H₂/C in the feedstock gas: 2.2
temperature at the center of reaction bed: 800° C.
reaction pressure: atmospheric.

A reformate gas having the following dry composition was obtained: 45.46% H₂, 8.19% CO, 9.6% CO₂, and 0.56% CH₄, N₂ balance.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

1. A catalyst, characterized by comprising an active component, a first additive and a second additive, wherein:
the active component is selected from precious metals of the platinum family and combinations and mixtures thereof, having an amount by weight thereof, based on the weight of metal(s) in elemental state, from 0.01% to 10% of the total weight of the active component, the first additive and the second additive;
the first additive is selected from alkali metal oxides, alkaline earth metal oxides and combinations and mixtures thereof, having an amount by weight thereof, based on the weight of oxides, from 1% to 8% of the total weight of the active component, the first additive and the second additive; and
the second additive is selected from CeO₂-based composite oxides, wherein the mole percentage of CeO₂ in the second additive is from 1% to 99%, and the amount of the second additive, based on the weight of oxides, is from 15% to 99% of the total weight of the active component, the first additive and the second additive.

2. A catalyst according to claim 1, characterized in that the active component is selected from Pt, Pd, Ru, Rh, Ir, and combinations and mixtures thereof.

3. A catalyst according to claim 2, characterized in that the active component is selected from Rh, Rh—Pd combination or mixture, Rh—Ir combination or mixture, and Rh—Pt combination or mixture.

4. A catalyst according to claim 1, characterized in that the first additive is selected from Na₂O, K₂O, MgO, CaO, SrO, BaO, and mixtures and combinations thereof.

5. A catalyst according to claim 4, characterized in that the first additive is selected from K₂O, MgO and CaO.

6. A catalyst according to claim 1, characterized in that the second additive is a two- or three-member composite material of CeO₂ and an oxide of a metal selected from: La, Pr, Nd, Sm, Eu, Gd, Y and Zr and combinations thereof.

7. A catalyst according to claim 6, characterized in that the second additive is selected from: Ce—Zr two-member composite oxide, Ce—Sm two-member composite oxide, and Ce—Zr—Y three-member composite oxide.

8. A catalyst according to claim 1, characterized in that the amount by weight of the active component is from 0.1% to 5% of the total weight of the active component, the first additive and the second additive.

9. A catalyst according to claim 1, characterized in that the amount by weight of the first additive is from 2% to 4% of the total weight of the active component, the first additive and the second additive.

10. A catalyst according to claim 1, characterized in that the amount by weight of the second additive is from 30% to 60% of the total weight of the active component, the first additive and the second additive.

11. A catalyst according to claim 10, characterized in that the mole percentage of CeO₂ in the second additive is from 40% to 60% of the total amount in moles of the second additive.

12. A catalyst according to claim 1, characterized in that the first additive is at least partly dispersed on the surface of the second additive, or partly enters the second additive to form a composite material.

13. A catalyst according to claim 1, characterized in that the second additive is a complete two-member or three-member composite Ruined by CeO₂ and oxide(s) of other metal(s), or a microcrystalline mixture of CeO₂ and oxide(s) of other metal(s).

14. A catalyst according to claim 13, characterized in that the second additive is a single-phase solid solution of CeO₂ and oxide(s) of other metal(s).

15. A catalyst according to claim 1, characterized in that the catalyst is essentially free of components other than the active component, the first additive and the second additive, with the second additive acting as a physical support of the active component.

16. A catalyst according to claim 1, characterize in that it further comprises an inert support material that acts as a physical support for the active component, the first additive and the second additive.

17. A catalyst according to claim 16, wherein the inert support material is selected from α-Al₂O₃, MgAl₂O₄, and CaTiO₃, with the catalyst being in pellet form.

18. A catalyst according to claim 16, which is in a monolithic forn, and with the inert support material being selected from a ceramic honeycomb, a metal honeycomb and a metal foam.

19. A process for making the catalyst according to claim 15, comprising:
(19-1) providing a CeO₂-based composite oxide material as a catalyst precursor A1;
(19-2) loading a compound of an alkali metal or an alkaline earth metal onto the catalyst precursor A1 resulting from step (19-1), followed by drying and calcination, to obtain a catalyst precursor B1;
(19-3) loading a compound of a precious metal of the platinum family onto the catalyst precursor B1 resulting from step (19-2), followed by drying and calcination, to obtain a catalyst C1 in the oxidized state; and
(19-4) reducing the catalyst C1 resulting from step (19-3).

20. A process for making the catalyst of claim 16, comprising:
(20-1) loading a CeO₂-based composite oxide material onto a catalyst support, followed by drying and calcination, to obtain a catalyst precursor A2;
(20-2) loading a compound of an alkali metal or an alkaline earth metal onto the catalyst precursor A2 resulting from step (20-1), followed by drying and calcination, to obtain a catalyst precursor B2;
(20-3) loading a compound of a precious metal of the platinum-family onto the catalyst precursor B2 resulting from step (20-2), followed by drying and calcination, to obtain a catalyst C2 in the oxidized state; and
(20-4) reducing the catalyst C2 resulting from step (20-3).

21-30. (canceled)
